(19) United States
(12) Patent Application Publication
(10) Pub. No.: US 2010/0053428 A1
(43) Pub. Date: Mar. 4, 2010

(54) IMAGE PROCESSING APPARATUS AND IMAGE PROCESSING METHOD, PROGRAM, AND IMAGE DISPLAY APPARATUS

(76) Inventors: Takayuki Ohe, Saitama (JP); Masato Usuki, Kanagawa (JP); Minoru Urushihara, Tokyo (JP); Kenkichi Kobayashi, Tokyo (JP); Koji Moriya, Chiba (JP)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/227,542

(22) PCT Filed: Mar. 19, 2008
(86) PCT No.: PCT/JP2008/055100

§ 371 Date: Nov. 16, 2009

(30) Foreign Application Priority Data
Mar. 23, 2007 (JP) 2007-077279

(51) Int. Cl. H04N 7/01

(52) U.S. Cl. 348/452; 348/E07.003

(57) ABSTRACT

The present invention relates to an image processing apparatus and an image processing method, a program, and an image display apparatus that are configured, when a predetermined image signal is superposed on an image signal before interpolation, to enhance the quality of an image signal after interpolation. A MPU 31 accepts a command for starting or ending superposition of a predetermined image signal onto an input image signal. If the command for starting or ending superposition is accepted, a interpolation processing block 72 detects a motion vector of an input image signal with superposition of a predetermined image signal started or ended and interpolates and outputs an interpolation signal on the basis of the motion vector regardless of a total reliability of the motion vector. The present invention is applicable to television receivers, for example.

### TECHNICAL FIELD

The present invention relates to an image processing apparatus and an image processing method, a program, and an image display apparatus, and more particularly to an image processing apparatus and an image processing method, a program, and an image display apparatus that are configured, when a predetermined image signal is superposed on an image signal before interpolation, to enhance the quality of an image signal after interpolation.

### BACKGROUND ART

Frame interpolation processing for interpolating an image signal between frames that is applied to high frame rate processing in which the frame rate of an image signal is made fast and motion compensation processing for compensating the motion of an image signal is indispensable for enhancing the picture quality of image signals.

For such frame interpolation processing, a method was devised in which a motion vector is obtained from an entered time-series image signal and, by use of the obtained motion vector, an image signal at a given time between time-series image signals is interpolated (refer to patent documents 1 for example).

In such frame interpolation processing, it is also possible that, if the value of a motion vector is in excess of a threshold, this motion vector is determined to be abnormal and no motion-vector based interpolation is executed, thereby suppressing the occurrence of an interpolation error due to the abnormal motion vector.

Patent document 1:

Japanese Patent Laid-open No. 2001-42831

### DISCLOSURE OF INVENTION

### Technical Problem

Now, if an image signal of an OSD (On Screen Display) image such as a channel number or a menu (hereafter referred to as an OSD image signal) is superposed on an entered time-series image signal, that OSD image signal is handled also as an image signal like a time-series image signal in frame interpolation processing, so that an OSD image signal not found in an immediately preceding image signal obtains a motion vector of an image signal that suddenly appeared, whereby a motion vector in a domain in which the OSD image signal is superposed is made to be an abnormal motion vector.

Therefore, in that case, although a motion vector in a domain in which no OSD image signal is superposed is a normal motion vector, the above-mentioned frame interpolation processing for suppressing an interpolation error makes the value of a motion vector superposed with an OSD image signal exceed a threshold, whereby a motion-vector based interpolation is sometimes not performed.

As a result, if there are an image interpolated by use of a motion vector and an image not interpolated by use of a motion vector at the same time, a difference between these images may be visually recognized as an image jerk. Especially, if an entered time-series image signal is an image signal of a moving image, there is a large difference in picture quality between a moving image moving smoothly due to the interpolation based on a motion vector and a moving image not interpolated, whereby viewers are given an unpleasant sensation.

The present invention has been made in consideration of the above-mentioned problems and therefore is intended to enhance the picture quality of interpolated image signals in the superposition of a predetermined image signal onto an uninterpolated image signal.

### Technical Solution

In carrying out the invention and according to a first aspect thereof, there is provided an image processing apparatus having detecting means for detecting a motion vector of an input image signal that is an entered time-series image signal; determining means for determining a level of a reliability of the motion vector; interpolating means for interpolating and outputting, if the reliability of the motion vector is high, on the basis of the motion vector, a signal between input image signals that is an image signal at a given time between the input image signal and a preceding input image signal that is an input image signal one before the input image signal and, if the reliability of the motion vector is low, outputting the preceding input image signal as the signal between input image signals without change; and accepting means for accepting a command for starting or ending superposition of a predetermined image signal onto the input image signal; wherein, if the command for starting or ending the superposition is accepted, the detecting means detects a motion vector of the input image signal with the superposition of the predetermined image signal started or ended and, if the command for starting or ending the interpolation is accepted, the interpolating means interpolates and outputs the signal between input image signals regardless of the reliability of the motion vector and on the basis of the motion vector.

The image processing apparatus of the first aspect of the present invention can further have superposing means for starting or ending, if the command for starting or ending the superposition is accepted, the superposition of the predetermined image signal onto the input image signal.

In the image processing apparatus of the first aspect of the present invention, the determining means can, if a value of the motion vector is smaller than a threshold value, determine that the reliability is high and, if a value of the motion vector is greater than a threshold value, determine that the reliability is low.

In the image processing apparatus of the first aspect of the present invention, the determining means can determine on the basis of a difference between the input image signal and the preceding input image signal, whether the input image signal is an image signal at a time of scene change and, if the input image signal is found to be not an image signal at a time of scene change, determine that the reliability is high and, if the input image signal is found to be an image signal at a time of scene change, determine that the reliability is low.

In the image processing apparatus of the first aspect of the present invention, the accepting means and the interpolating means are interconnected via a bus; the accepting means can, upon accepting the command for starting or ending the superposition, transmit a stop signal indicative of stopping of suppression of interpolation by the interpolating means to the interpolating means before the interpolation is started or ended; and the interpolating means can, upon receiving the stop signal from the accepting means, interpolate and outputs the signal between input image signals on the basis of the motion vector regardless of the reliability of the motion vector.

In the image processing apparatus of the first aspect of the present invention, the accepting means can, upon accepting the command for starting or ending the superposition, put a port into a state indicative of stopping suppression of the interpolation by the interpolating means before the superposition is started or ended; and the interpolating means can confirm the state of the port by polling before the superposition is started or ended and, if the state of the port is indicative of stopping of suppression of the interpolation by the interpolating means, interpolate and output the signal between input image signals on the basis of the motion vector regardless of the reliability of the motion vector.

In carrying out the present invitation and according to the first aspect thereof, there is provided an image processing method for an information processing apparatus configured to detect a motion vector of an input image signal that is an entered time-series image signal, determine a level of a reliability of the motion vector, interpolate and output, if the reliability of the motion vector is high, on the basis of the motion vector, a signal between input image signals that is an image signal at a given time between the input image signal and a preceding input image signal that is an input image signal one before the input image signal, and, if the reliability of the motion vector is low, output the preceding input image signal as the signal between input image signals without change, the image processing method having the steps of accepting a command for starting or ending superposition of a predetermined image signal onto the input image signal; if the command for starting or ending the superposition is accepted, detecting a motion vector of the input image signal with the superposition of the predetermined image signal started or ended; and if the command for starting or ending the superposition is accepted, interpolating and outputting the signal between input image signals on the basis of the motion vector regardless of the reliability of the motion vector.

In carrying out the invention and according to the first aspect thereof, there is provided a program for making a computer execute image processing for detecting a motion vector of an input image signal that is an entered time-series image signal, determining a level of a reliability of the motion vector, interpolating and outputting, if the reliability of the motion vector is high, on the basis of the motion vector, a signal between input image signals that is an image signal at a given time between the input image signal and a preceding input image signal that is an input image signal one before the input image signal, and, if the reliability of the motion vector is low, outputting the preceding input image signal as the signal between input image signals without change, the program having the steps of: accepting a command for starting or ending superposition of a predetermined image signal onto the input image signal; if the command for starting or ending the superposition is accepted, detecting a motion vector of the input image signal with the superposition of the predetermined image signal started or ended; and if the command for starting or ending the superposition is accepted, interpolating and outputting the signal between input image signals on the basis of the motion vector regardless of the reliability of the motion vector.

In carrying out the invention and according to a second aspect thereof, there is provided an image display apparatus having: detecting means for detecting a motion vector of an input image signal that is an entered time-series image signal; determining means for determining a level of a reliability of the motion vector; interpolating means for interpolating and outputting, if the reliability of the motion vector is high, on the basis of the motion vector, a signal between input image signals that is an image signal at a given time between the input image signal and a preceding input image signal that is an input image signal one before the input image signal and, if the reliability of the motion vector is low, outputting the preceding input image signal as the signal between input image signals without change; accepting means for accepting a command for starting or ending superposition of a predetermined image signal onto the input image signal; and display means for display an image on the basis of the input image signal, the preceding input image signal, or the signal between input image signal; wherein, if the command for starting or ending the superposition is accepted, the detecting means detects a motion vector of the input image signal with the superposition of the predetermined image signal started or ended and, if the command for starting or ending the interpolation is accepted, the interpolating means interpolates and outputs the signal between input image signals regardless of the reliability of the motion vector and on the basis of the motion vector.

The image display apparatus of the second aspect of the present invention can further have superposing means for starting or ending, if the command for starting or ending the superposition is accepted, the superposition of the predetermined image signal onto the input image signal.

In the image display apparatus of the second aspect of the present invention, the determining means can, if a value of the motion vector is smaller than a threshold value, determine that the reliability is high and, if a value of the motion vector is greater than a threshold value, determine that the reliability is low.

In the image display apparatus of the second aspect of the present invention, the determining means can determine on the basis of a difference between the input image signal and the preceding input image signal, whether the input image signal is an image signal at a time of scene change, if the input image signal is found to be not an image signal at a time of scene change, determine that the reliability is high and, if the input image signal is found to be an image signal at a time of scene change, determine that the reliability is low.

In the image display apparatus of the second aspect of the present invention, the accepting means and the interpolating means are interconnected via a bus; the accepting means can, upon accepting the command for starting or ending the superposition, transmit a stop signal indicative of stopping of suppression of interpolation by the interpolating means to the interpolating means before the interpolation is started or ended; and the interpolating means can, upon receiving the stop signal from the accepting means, interpolate and output the signal between input image signals on the basis of the motion vector regardless of the reliability of the motion vector.

In the image display apparatus of the second aspect of the present invention, the accepting means can, upon accepting the command for starting or ending the superposition, put a port into a state indicative of stopping suppression of the interpolation by the interpolating means before the superposition is started or ended; and the interpolating means can confirm the state of the port by polling before the superposition is started or ended and, if the state of the port is indicative of stopping of suppression of the interpolation by the interpolating means, interpolate and output the signal between input image signals on the basis of the motion vector regardless of the reliability of the motion vector.

In the first aspect of the present invention, image processing is executed by detecting a motion vector of an input image signal that is an entered time-series image signal, determining a level of a reliability of the motion vector, interpolating and outputting, if the reliability of the motion vector is high, on the basis of the motion vector, a signal between input image signals that is an image signal at a given time between the input image signal and a preceding input image signal that is an input image signal one before the input image signal, and, if the reliability of the motion vector is low, outputting the preceding input image signal as the signal between input image signals without change. It should be noted that, if the command for starting or ending the superposition of the predetermined image signal onto the input image signal is accepted, a motion vector of the input image signal with the superposition of the predetermined image signal started or ended is detected; and if the command for starting or ending the superposition is accepted, the signal between input image signals are interpolated and outputted on the basis of the motion vector regardless of the reliability of the motion vector.

In the second aspect of the present invention, image processing is executed by detecting a motion vector of an input image signal that is an entered time-series image signal, determining a level of a reliability of the motion vector, interpolating and outputting, if the reliability of the motion vector is high, on the basis of the motion vector, a signal between input image signals that is an image signal at a given time between the input image signal and a preceding input image signal that is an input image signal one before the input image signal, and, if the reliability of the motion vector is low, outputting the preceding input image signal as the signal between input image signals without change, and displaying images on the basis of the input image signal, the preceding input image signal, and the signal between input image signals. It should be noted that, if the command for starting or ending the superposition of the predetermined image signal onto the input image signal is accepted, a motion vector of the input image signal with the superposition of the predetermined image signal started or ended is detected; and if the command for starting or ending the superposition is accepted, the signal between input image signals are interpolated and outputted on the basis of the motion vector regardless of the reliability of the motion vector.

### ADVANTAGEOUS EFFECT

As described above, according to the present invention, if a predetermined image signal is superposed on an image signal before interpolation, the picture quality of the interpolated image signal can be enhanced.

### BRIEF DESCRIPTION OF DRAWINGS

FIG. 1 is a block diagram illustrating an exemplary configuration of a first embodiment of a receiving apparatus to which the present invention is applied.

FIG. 2 is a block diagram illustrating interpolation in the receiving apparatus shown in FIG. 1.

FIG. 3 is a block diagram illustrating an exemplary detail configuration of an interpolation processing block shown in FIG. 2.

FIG. 4 is a timing chart indicative of the on or off timing of a protection function of the receiving apparatus shown in FIG. 1.

FIG. 5 is a flowchart indicative of control processing in the receiving apparatus shown in FIG. 1.

FIG. 6 is a flowchart indicative of image processing in the receiving apparatus shown in FIG. 1.

FIG. 7 is a flowchart indicative of details of interpolation processing of step S33 shown in FIG. 6.

FIG. 8 is a block diagram illustrating an exemplary configuration of a second embodiment of a receiving apparatus to which the present invention is applied.

FIG. 9 is a block diagram illustrating interpolation in the receiving apparatus shown in FIG. 8.

FIG. 10 is a timing chart indicative of an on or off timing of a protection function in the receiving status shown in FIG. 8.

FIG. 11 is a flowchart indicative of control processing in the receiving apparatus shown in FIG. 8.

FIG. 12 is a flowchart indicative of polling processing in a CPU shown in FIG. 9.

FIG. 13 is a flowchart indicative of image processing in the receiving apparatus shown in FIG. 8.

FIG. 14 is a block diagram illustrating a third embodiment of a receiving apparatus to which the present invention is applied.

FIG. 15 is a block diagram illustrating interpolation in the receiving apparatus shown in FIG. 14.

FIG. 16 is a flowchart indicative of control processing in the receiving apparatus shown in FIG. 14.

FIG. 17 is a flowchart indicative of the transmission processing in a recording/reproducing apparatus.

FIG. 18 is a flowchart indicative of protection function control processing in an MPU shown in FIG. 14.

FIG. 19 is a flowchart indicative of image processing in an image processing block shown in FIG. 14.

FIG. 20 is a diagram illustrating a cursor moving time on an OSD image.

### EXPLANATION OF REFERENCE SYMBOLS

11 Receiving apparatus, 31 MPU, 37 Bus, 71 OSD superposing block, 82 Detecting block, 83 Moving block, 84 Decision block, 85 Mixing block, 101 Receiving apparatus, 131 OSD superposing block, 132 CPU, 132A Port, 143 CPU, 201 Receiving apparatus, 211 MPU, 234 OSD superposing block

### BEST MODE FOR CARRYING OUT THE INVENTION

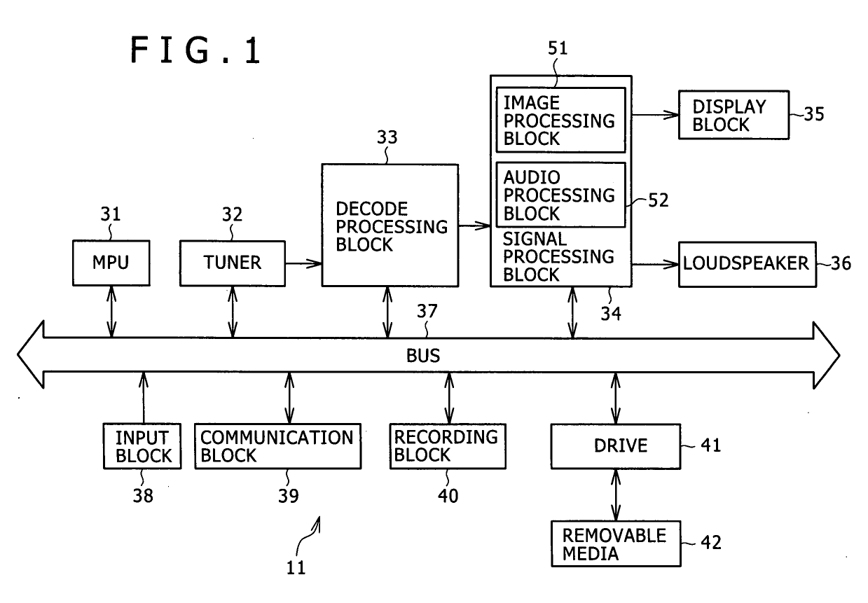

FIG. 1 shows an exemplary configuration of a first embodiment of a receiving apparatus to which the present invention is applied.

In a receiving apparatus 11 shown in FIG. 1, an MPU (Micro Processing Unit) 31, a tuner 32, a decode processing block 33, a signal processing block 34 with a display block 35 and a loudspeaker 36 connected, an input block 38, a communication block 39, a recording block 40, and a drive 41 are interconnected via a bus 37. The receiving apparatus 11 receives radio waves of digital signals (hereafter referred to as program signals) of image and sound in time-series frame unit of a program and outputs the image and sound of that program.

The MPU 31 executes a program installed in the recording block 40, for example, to execute various processes in response to commands and so on entered from the input block 38. For example, in response to a command for displaying a program on a user-desired channel, the MPU 31 controls the tuner 32, the decode processing block 33, and the signal processing block 34 to display an image corresponding to a program signal of that channel onto the display block 35 made up of a liquid crystal panel or the like and output sound from the loudspeaker 36. The same time, in response to a command for starting the displaying of an OSD image, the MPU 31 controls the decode processing block 33 to superpose an OSD image signal onto an image signal of program signals.

In addition, the MPU 31 installs, on the recording block 40, as required, programs downloaded via the communication block 39 and programs recorded to a removable media 42 such as a magnetic disk, an optical disk, a magneto-optical disk, or a semiconductor memory loaded on the drive 41.

The tuner 32 receives, under the control of the MPU 31, a radio wave of a program signal radiated from a broadcasting station, not shown, and demodulates the received radio wave. The tuner 32 supplies a program signal obtained as a result of the demodulation to the decode processing block 33.

The decode processing block 33, under the control of the MPU 31, decodes the program signal (the encoded program signal) supplied from the tuner 32 in a predetermined method such as MPEG2 (Moving Picture Experts Group phase 2) and supplies a program signal obtained as a result thereof to the signal processing block 34.

The signal processing block 34 is constituted by an image processing block 51 and an audio processing block 52. The image processing block 51 executes such processing as superposition of an OSD image signal onto an image signal of program signals supplied from the decode processing block 33, interpolation of an image signal at an intermediate time in continuous image signals, and D/A (Digital/Analog) conversion. The image processing block 51 supplies an image signal that is an analog signal obtained as a result of the above-mentioned processing to the display block 35 to display an image on the display block 35.

The audio processing block 52 executes D/A conversion and so on on an audio signal of programs signals supplied from the decode processing block 33 and supplies an audio signal obtained as a result thereof to the loudspeaker 36 to output sound to the outside.

The input block 38 is constituted by a receiving block for receiving a command transmitted from the remote controller, not shown, buttons, a keyboard, a mouse, switches, and so on, thereby receiving a user command. The input block 38, in response to a user command, supplies various commands to the MPU 31 via the bus 37.

For example, in response to a command for displaying a program on a user-desired channel, the input block 38 supplies a command for displaying a program of a user-desired channel to the MPU 31. Also, in response to a command for starting or ending the displaying of an OSD image from the user, the input block 38 supplies a command for starting or ending the displaying of an OSD image to the MPU 31.

The communication block 39 transfers various kinds of data via a network, such as the Internet, not shown. Also, the communication block 39 downloads a predetermined program from a server, not shown, via a network and supplies the downloaded program to the MPU 31. The recording block 40 records programs to be executed by the MPU 31 and various kinds of data, as required.

On the drive 41, the removable media 42 is loaded as required. The drive 41 drives the removable media 42 to read programs and data recorded thereto and supplies these programs and data to the MPU 31 via the bus 37.

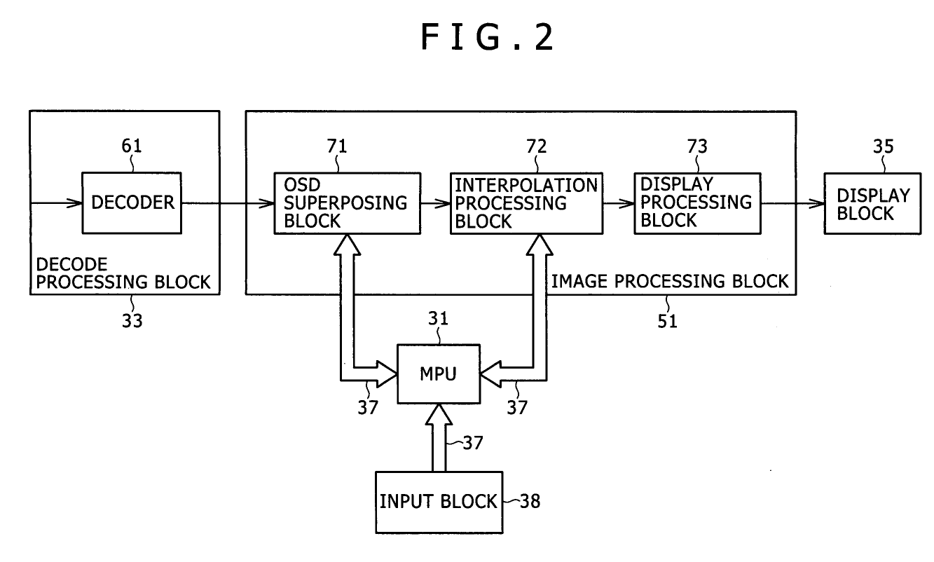

The following describes interpolation in the receiving apparatus 11 shown in FIG. 1 with reference to FIG. 2.

As shown in FIG. 2, receiving a command for starting or ending the displaying of an OSD image from the user, the input block 38 supplies this command to the MPU 31 via the bus 37.

The MPU 31 executes such communication with the image processing block 51 via the bus 37 as 12C (Inter-Integrated Circuit) communication and UART (Universal Asynchronous Receiver Transmitter). For example, in response to an OSD image display start command supplied from the input block 38, the MPU 31 transmits a protection function off signal indicative of an off-state of a protection function for suppressing interpolation if an interpolation error occurs to the image processing block 51 and then transmits an OSD image signal to the image processing block 51.

Also, in response to an OSD image display end command supplied from the input block 38, the MPU 31 transmits a protection function off signal to the image processing block 51 and then transmits an OSD image signal superposition stop command to the image processing block 51. Further, the MPU 31 transmits a protection function on signal indicative of an on-state of the protection function.

As shown in FIG. 2, the decode processing block is constituted by a decoder 61. The decoder 61 decodes a program signal entered from the tuner 32 shown in FIG. 1 and supplies an image signal (hereafter referred to as an input image signal) obtained as a result thereof to the image processing block 51. It should be noted that an audio signal obtained after decoding is supplied to the audio processing block 52 shown in FIG. 2.

The image processing block 51 is constituted by an OSD superposing block 71, an interpolation processing block 72, and a display processing block 73. The OSD superposing block 71 superposes an OSD image signal supplied from the MPU 31 via the bus 37 onto an input image signal supplied from the decoder 61 and supplies the superposed input image signal to the interpolation processing block 72. Also, the OSD superposing block 71 supplies the input image signal supplied from the decoder 61 directly to the interpolation processing block 72.

The interpolation processing block 72, in response to a protection function off signal or a protection function on signal supplied from the MPU 31 via the bus 37, executes interpolation on the input image signal supplied from the OSD superposing block 71. The interpolation processing block 72 supplies an interpolated image signal to the display processing block 73.

The display processing block 73 executes D/A conversion on the interpolated image signal supplied from the interpolation processing block 72 and supplies an image signal that is an analog signal obtained as a result thereof to the display block 35 to display an image on the display block 35.

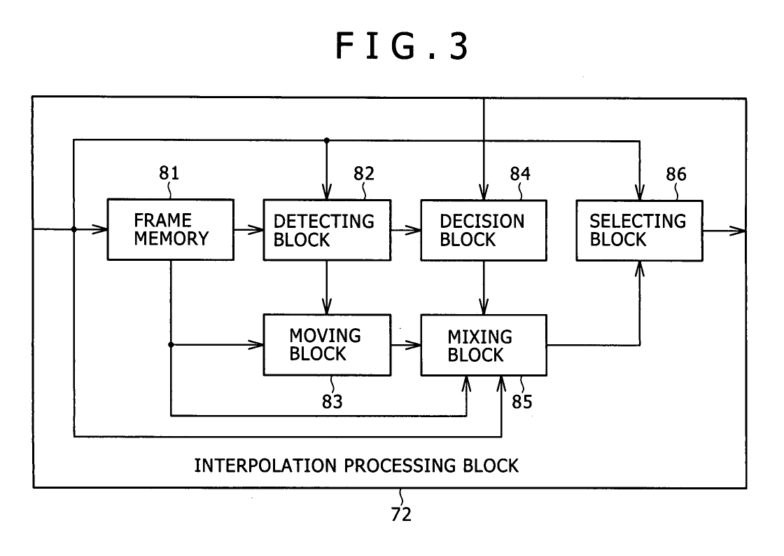

FIG. 3 shows an exemplary detail configuration of the interpolation processing block 72 shown in FIG. 2.

The interpolation processing block 72 is constituted by a frame memory 81, a detecting block 82, a moving block 83, a decision block 84, a mixing block 85, and selecting block 86.

The input image signal supplied from the OSD superposing block 71 shown in FIG. 2 is entered in the frame memory 81, the detecting block 82, the mixing block 85, and the selecting block 86. The protection function off signal or the protection function on signal supplied from the MPU 31 via the bus 37 is supplied to the decision block 84.

The frame memory 81 stores, on a frame basis, the input image signal entered from the OSD superposing block 71. The frame memory 81 reads the input image signal stored last, namely, the input image signal (hereafter referred to as a preceding input image signal) one frame before the input image signal entered from the OSD superposing block 71 and supplies the signal to the detecting block 82, the moving block 83, and the mixing block 85.

The detecting block 82 uses the input image signal entered from the OSD superposing block 71 as an input image signal subject to detection (hereafter referred to as an target input image signal) and, on the basis of the target input image signal and the preceding input image signal one frame before the target input image signal, supplied from the frame memory 81, detects a motion vector of the target input image signal.

For example, the detecting block 82, in accordance with the block matching method, makes a match between a base block set to the target input image signal and a reference block of the same size as the reference block, set to the preceding input image signal, thereby detecting a motion vector on a block basis. The detecting block 82 supplies the detected block-basis motion vector to the moving block 83 and the decision block 84.

The moving block 83 uses a block-basis motion vector supplied from the detecting block 82 to move, on the block basis, the preceding input image signal supplied from the frame memory 81 and supplies the moved preceding input image signal to the mixing block 85.

On the basis of the block-basis motion vector supplied from the detecting block 82, the decision block 84 determines the reliability (hereafter referred to as block reliability) of the block-basis motion vector. Also, in response to the protection function off signal supplied from the MPU 31, the decision block 84 turns off the protection function and, in response to the protection function on signal, turns on the protection function. Namely, the decision block 84 stops the suppression of interpolation in accordance with the off signal of the protection function and starts the suppression of interpolation in accordance with the on signal of protection function.

If the protection function is on, the decision block 84 determines on the basis of the value of the block-basis motion vector a level of the reliability of all motion vectors (hereafter referred to as a total reliability). To be more specific, if the value of at least one of the block-basis motion vectors is higher than a preset threshold, the decision block 84 determines that the total reliability is low; if all values of the block-basis motion vectors are smaller than the threshold, the decision block 84 determines that the total reliability is high.

If the total reliability is determined to be high, the decision block 84 determines that no interpolation error occurs in the interpolation based on the motion vector and, on the basis of the block reliability, determines a ratio of mixing (hereafter referred to as a mixing ratio) the target input image signal and the moved preceding input image signal on a block basis. The decision block 84 supplies this block-basis mixing ratio to the mixing block 85.

On the other hand, if the total reliability is determined to be low, the decision block 84 determines that an interpolation error occurs due to the motion vector in the interpolation based on the motion vector and supplies no-mixing information indicative that the target input image signal and the moved preceding input image signal are not mixed to the mixing block 85.

Also, if the protection function is off, the decision block 84 determines a block-basis mixing ratio not on the basis of the total reliability of the motion vectors supplied from the detecting block 82 but on the basis of the block reliability and supplies that mixing ratio to the mixing block 85.

On the basis of the mixing ratio supplied from the decision block 84, the mixing block 85 mixes the target input image signal supplied from the OSD superposing block 71 and the preceding input image signal supplied from the moving block 83. The mixing block 85 supplies the mixed image signal to the selecting block 86 as an interpolation signal for interpolating an image signal at a time that is intermediate between the target input image signal and the preceding input image signal.

As described above, if the mixing ratio is determined by the decision block 84, the mixing block 85, on the basis of this mixing ratio, executes interpolation based on the mixing of the target input image signal and the preceding input image signal moved by use of a motion vector by the moving block 83. Namely, if the protection function is on and the total reliability is high or, if the protection function is off, the moving block 83 and the mixing block 85 execute the interpolation by use of a motion vector.

In addition, in response to no-mixing information supplied from the decision block 84, the mixing block 85 supplies the preceding input image signal supplied from the frame memory 81 to the selecting block 86 as an interpolation signal without change. Namely, if the protection function is on and the total reliability is low, the moving block 83 and the mixing block 85 do not execute the interpolation by use of a motion vector.

The selecting block 86 selects one of the target input image signal entered from the OSD superposing block 71 and the interpolation signal supplied from the mixing block 85 and outputs the selected signal as an interpolated image signal with a predetermined timing. To be more specific, the selecting block 86 outputs, between the target input image signal and a following target input image signal, an interpolation signal generated by use of these signals, as an interpolated image signal. As a result, a frame rate of the interpolated signal outputted from the selecting block 86 becomes two times as high as the frame rate of the input image signal.

It should be noted that, in the above description, the decision block 84 determines the level of the total reliability based on the value of a block-basis motion vector; however, it is also practicable to determine the level of the total reliability on the basis whether the target input image signal is an image signal at a scene change when the detection of an abnormal motion vector is highly possible.

In this case, for example, on the basis of a difference between the corresponding pixels of the base block and the reference block, the detecting block 82 determines whether the target input image signal is an image signal at a scene change. To be more specific, the detecting block 82 computes a block-basis integrated value of differences between the corresponding pixels of the base block and the reference block and, if at least one of these block-basis integrated values is higher than a preset threshold value, the decision block 84 determines that the target input image signal is an image signal at a scene change and, if all of the block-basis integrated values are less than the threshold value, determines that the target input image signal is not an image signal at a scene change.

Then, if the target input image signal is found to be an image signal at scene change, the detecting block 82 determines that the total reliability is low; if the target input image signal is found to be not an image signal at scene change, the detecting block 82 determines that the total reliability is high.

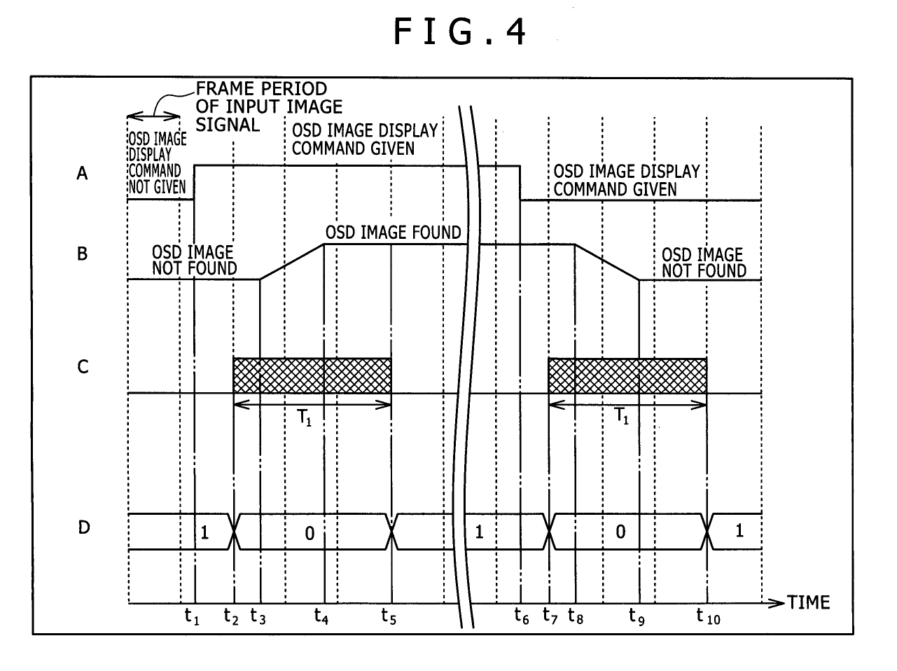

The following describes the on or off timing of the protection function with reference to FIG. 4. It should be noted that, in FIG. 4, the horizontal axis is representative of time in which one frame period is assumed to be 1/60 second.

As shown in A of FIG. 4, if, at time t₁ in a frame period of a first input image signal supplied from the decoder 61, for example, an OSD image display start command is supplied from the input block 38 to the MPU 31 via the bus 37, the MPU 37 supplies a protection function off signal; to the interpolation processing block 72 via the bus 37 at time t₂ when a second input image signal of a frame next to the first input image signal is entered in the interpolation processing block 72.

As a result, as shown in D of FIG. 4, the decision block 84 of the interpolation processing block 72 turns off the protection function from the point of time at which the second input image signal becomes the target input image signal. It should be noted that, in D of FIG. 4, the on state of the protection function is denoted by “1” and the off-state of the protection function is denoted by “0.”

Then, the MPU 31 transmits the OSD image signal to the OSD superposing block 71 via the bus 37. Consequently, in the example shown in FIG. 4, as shown in B of FIG. 4, OSD image signal are gradually superposed from time t₃ in the frame period of the second input image signal supplied from the decoder 61 to time t₄ in the frame period of the third input image signal next to the second input image signal and, at time t₄, the superposition of all OSD image signal subject to display is completed. Next, at time t4 and on, until all OSD image signals subject to display are superposed until the stop of the OSD image signal starts. It should be noted that the duration from the start of the OSD image signal superposition to the end thereof depends on the image size of each OSD image.

Meanwhile, as described above, the detecting block 82 detects a block-basis motion vector based on a target input image signal and a preceding input image signal. Therefore, an OSD image signal is superposed on either one of a target input image signal and a preceding input image signal, and, if different parts of an OSD image signal are superposed on both a target input image signal and a preceding input image signal, a motion vector higher than a threshold is detected by the OSD image signal superposed on a target input image signal or a preceding input image signal, possibly giving a determination that the total reliability is low.

Namely, in the example shown in FIG. 4, as shown in C of FIG. 4, it is possible that the total reliability is determined to be low during period T₁ that is equivalent to three frame periods from when the second input image signal with the superposition of an OSD signal started becomes a target input image signal to when a fifth input image signal three frames after a second input image signal becomes a target input image signal on which the superposition of all OSD image signals is executed also on the input image signal one frame before.

Therefore, if the protection function is on, it is possible that, while a motion vector in an area with an OSD image signal is not superposed is normal, no interpolation by use of the motion vector is executed during period T₁. As a result, if the interpolation by use of a motion vector is not executed, a difference in picture quality between an image not interpolation and an interpolated image before or after the image not interpolated is visually recognized as a jerk in image. Especially, if an input image signal is an image signal of a moving image, a difference in picture quality between a moving image having a smooth motion due to the interpolation based on a motion vector and a moving image without the interpolation is great, thereby giving a viewer an unpleasant sensation or a shock.

So, the MPU 31 sets the protection function to an off state during period T₁ as shown in D of FIG. 4 by entering a protection function off signal into the interpolation processing block 72 at time t2 and entering a protection function on signal into the interpolation processing block 72 at time T5. Consequently, even if the total reliability is determined to be low due to an OSD image signal, the interpolation based on a motion vector is executed, thereby suppressing the jerk in image to enhance the picture quality of interpolated images. As a result, the unpleasant sensation or shock felt by a viewer can be suppressed.

It should be noted that the length of period T₁ depends on a performance of the OSD superposing block 71 and a detection method of the detecting block 82 and is set accordingly.

Next, as shown in A of FIG. 4, if an OSD image display end command is supplied from the input block 38 to the MPU 31 via the bus 37 at time t₆ in the frame period of a 11th input image for example supplied from the decoder 61, the processing similar to the case in which the displaying of an OSD image is started. To be more specific, at time t₇ when a 12th input image signal next to the 11th input image signal is entered in the interpolation processing block 72, the MPU 37 supplies a protection function off signal to the interpolation processing block 72 via the bus 37.

As a result, as shown in D of FIG. 4, the decision block 84 of the interpolation processing block 72 turns off the protection function when the 12th input image signal becomes the target input image signal. Then, the MPU 31 commands, via the bus 37, the OSD superposing block 71 to stop the superposition of the OSD image signal. Consequently, in the example shown in FIG. 4, as shown in B of FIG. 4, the superposition of OSD images is gradually stopped from time t₈ in a frame period of the 12th input image signal supplied from the decoder 61 to time t₉ in a frame period of a 13th input image signal next to the 12th input image signal and, at time t₉, the superposition of all OSD image signals subject to display stops. And, at time t₉ and on, until the superposition of OSD signals starts, the OSD image signal superposition is not executed. It should be noted that the period from starting of the stop of OSD image signal superposition to the completion thereof depends on the image size of OSD image.

As described above, the stop of the superposition starts from time t₈ in the frame period of the 12th input image signal supplied from the decoder 61 and the stop of the superposition of all OSD image signals is completed at time t₉ in the frame period of the 13th input image signal next to the 12th input image signal, so that it is highly possible that the total reliability is low during period T₁ that is equivalent to three frame periods from time t₇ when the 12th input image signal becomes the target input image signal to time t₁₀ when a 15th input image signal three frames after the 12th input image signal becomes the target input image signal.

Therefore, the MPU 31 enters a protection function off signal into the interpolation processing block 72 at time t₇ and enters a protection function on signal into the interpolation processing block 72 at time t₁₀ to set off the protection function during period T₁ as shown in D of FIG. 4. Consequently, even if it is determined that the total reliability is low by the OSD image signal, the interpolation based on a motion vector is executed, thereby enhancing the image quality of the interpolated image.

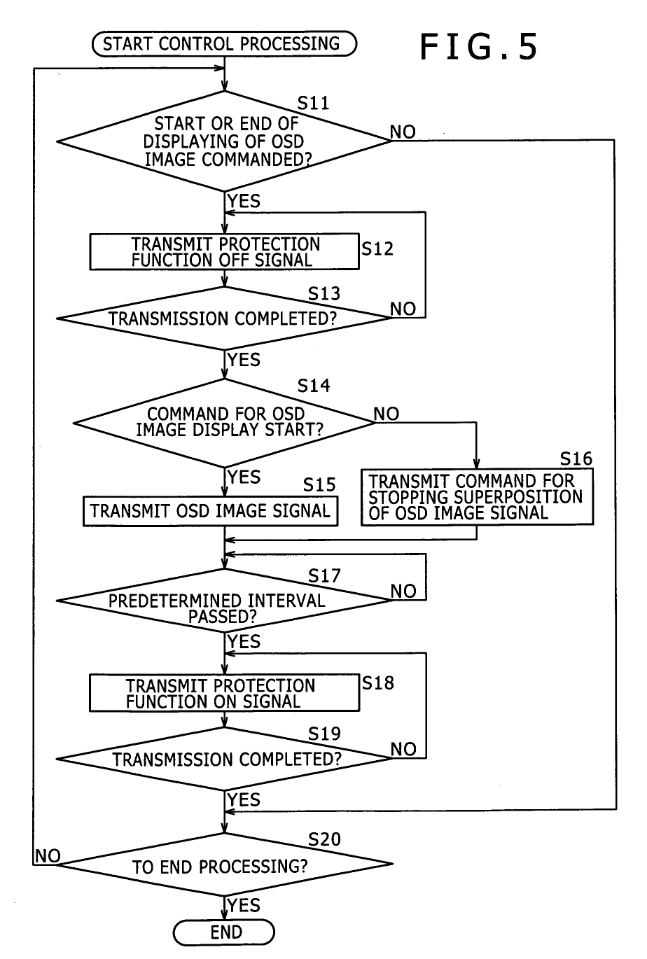

The following describes control processing that is executed in the receiving apparatus 11 shown in FIG. 1 with reference to FIG. 5. This control processing is started when the receiving apparatus 11 is powered on, for example.

In step S11, the MPU 31 determines whether a command has come from the input block 38 to start or end the display of OSD images. If the command is found in step S11 for neither starting nor stopping the display of OSD images, then the procedure skips steps S12 through S19 to step S20.

On the other hand, if the command is found in step S11 for starting or ending the display of OSD images, the MPU 31 transmits, in step S12, a protection function off signal to the interpolation processing block 72 via the bus 37 when an input image signal in a frame next to an input image signal that is entered in the interpolation processing block 72 when the command for starting or stopping the display of OSD images is entered in the interpolation processing block 72.

In step S13, the MPU 31 determines whether the transmission has been completed, namely, whether information (for example, ACK (Acknowledgement)) indicative of the normal reception from the decision block 84 of the interpolation processing block 72 in response to the transmission in step S12 has been received or not.

If the transmission is found not completed in step S13, then the procedure is returned to step S12 to repeatedly transmit a protection function off signal until the transmission is found completed in step S13. If the transmission is found completed in step S13, the MPU 31 determines, in step S14, whether the command determined in step S11 is a command for starting the display of OSD images.

If the command is found to be for the start of the display of OSD image signal in step S14, the MPU 31 transmits, in step S15, an OSD image signal to the OSD superposing block 71 via the bus 37. On the other hand, if the command is found to be not for the start of the display of OSD images, namely, the command is found to be for the end of the display of OSD images, the MPU 31 transmits, in step S16, a command for stopping the superposition of an OSD signal to the OSD superposing block 71 via the bus 37.

As described above, the MPU 31 transmits the command for stopping the superposition of an OSD image signal or OSD images after confirming the completion of transmission, so that a protection function off signal can be surely transmitted before the command for stopping the superposition of an OSD signal or OSD images.

After the processing of step S15 or step S16, the MPU 31 determines in step S17 whether a predetermined period T1 has passed since the transmission of the protection function off signal in step S12. If the predetermined period T1 is not passed in step S17, the MPU 31 waits until the predetermined period T1 passes. If the predetermined period T1 is found passed in step S17, the MPU 31 transmits the protection function on signal to the interpolation processing block 72 via the bus 37 in step S18.

In step S19, the MPU 31 determines whether information indicative of the completion of the transmission has been received, namely, indicative of the normal reception from the decision block 84 of the interpolation processing block 72 in response to the transmission of step S18 has been received or not. If the transmission is found not completed, the procedure is returned to step S18 to repetitively transmit a protection function on signal until the transmission is found completed in step S19.

If the transmission is found completed in step S19, the MPU 31 determines in step S20 whether to end the processing or not, for example, a power-off command has come from the input block 38. If the processing is found not to be ended in step S20, then the procedure returns to step S11 to repeat the above-mentioned processing. On the other hand, if the processing is found to be ended in step S20, the processing comes to an end.

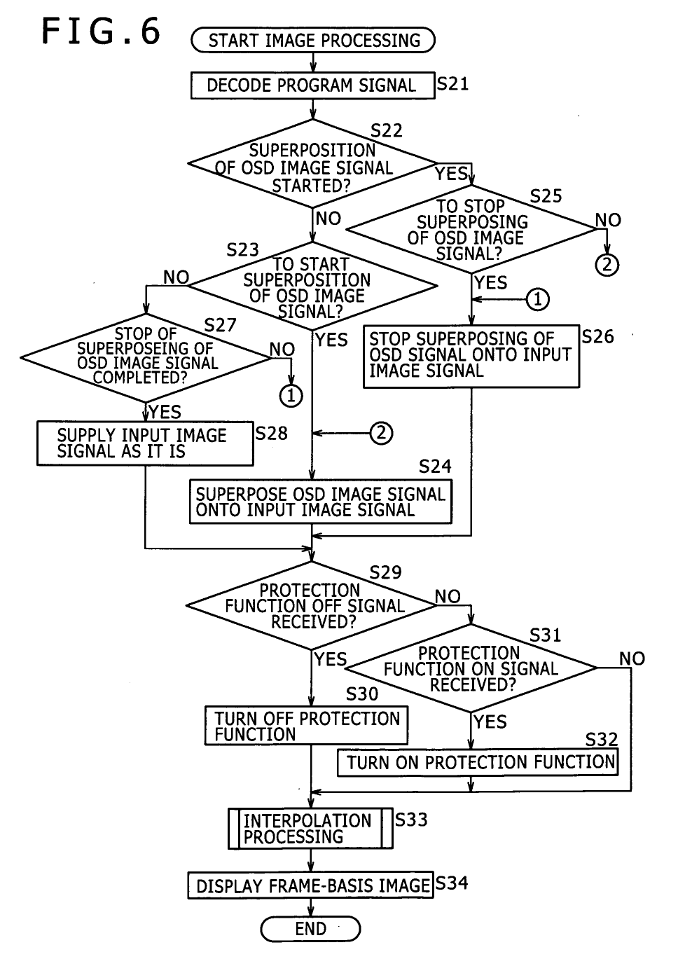

Next, the following describes image processing that is executed in the receiving apparatus 11 shown in FIG. 1 with reference to FIG. 6. This image processing starts when a program signal is entered from the tuner 32 into the decode processing block 33, for example.

In step S21, the decoder 61 decodes a program signal and supplies an image signal obtained as a result thereof to the OSD superposing block 71 of the image processing block 51 as an input image signal and supplies an audio signal to the audio processing block 52. In step S22, the OSD superposing block 71 determines whether the superposition of an OSD image signal has already started and, if the superposition of an OSD image signal is found not yet started, the procedure goes to step S23.

In step S23, the OSD superposing block 71 determines whether to start the superposition of an OSD image signal or not, namely, whether an OSD image signal was received in step S15 of FIG. 5. If the superposition of an OSD image signal is found to be started in step S23, the OSD superposing block 71 superposes, in step S24, the received OSD image signal onto an input image signal supplied from the decoder 61 and supplies the superposed input image signal to the interpolation processing block 72.

On the other hand, if the superposition of an OSD image signal is found started in step S22, the OSD superposing block 71 determines in step S25 whether the superposition of an OSD signal is to be stopped or not, namely, whether a command of stopping the superposition of an OSD image signal has been received from the MPU 31 in step S16 of FIG. 5. If the superposition of an OSD image signal is found to be stopped in step S25, the OSD superposing block 71 gradually stops the superposition of an OSD image signal onto an input image signal in step S26. The OSD superposing block 71 supplies the input image signal with the superposition of an OSD image signal gradually stopped to the interpolation processing block 72.

If the superposition of an OSD image signal is found not to be stopped in step S25, the OSD superposing block 71 superposes the received OSD image signal onto an input image signal in step S24 as described above.

Further, if the superposition of an OSD image signal is found not to be started in step S23, the OSD superposing block 71 determines in step S27 whether the stop of the superposition of an OSD image signal has been completed or not, namely, whether the OSD image signal has not been superposed onto the preceding input image signal at all.

If the end of the superposition of an OSD image signal is found not completed in step S27, the OSD superposing block 71 gradually stops the superposition of an OSD image signal onto an input image signal in step S26 as described above.

On the other hand, if the stop of the superposition of an OSD image signal is found completed in step S27, the OSD superposing block 71 supplies the input image signal to the interpolation processing block 72 without change.

In step S29 after the processing of step S24, S26, or S28, the decision block 84 determines whether a protection function off signal has been received from the MPU 31 in step S12 of FIG. 5. If a protection function off signal is found received in step S29, the decision block 84 turns off the protection function and the procedure goes to step S33.

If, in step S29, a protection function off signal is found not received, the decision block 84 determines in step S31 whether a protection function on signal that was supplied from the MPU 31 in step S18 of FIG. 5 has been received. If a protection function on signal is found received in step S32, the decision block 84 turns on the protection function in step S31 and the procedure goes to step S33. On the other hand, if a protection function on signal is found not received in step S31, the protection function is not changed, upon which the procedure goes to step S33.

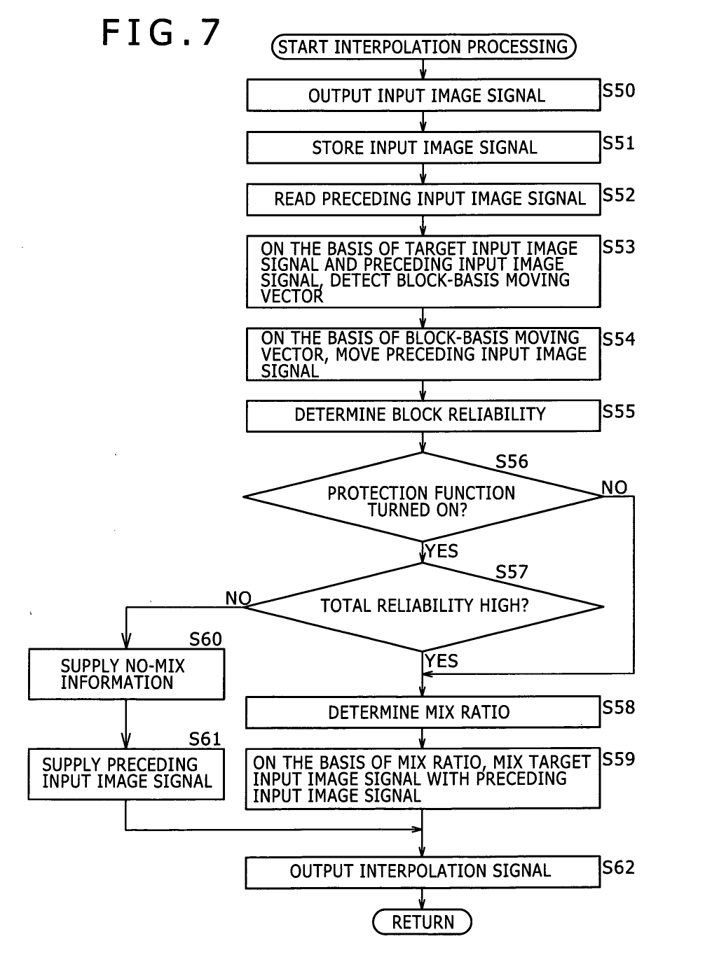

In step S33, the interpolation processing block 72 executes interpolation processing for interpolating an input image signal. Details of this interpolation processing will be described later with reference to FIG. 7. In step S34, the display processing block 73 executes D/A conversion on the interpolated image signal supplied from the interpolation processing block 72 and supplies the image signal that is an analog signal obtained as a result thereof to the display block 35 to display the image on the display block 35 on a frame basis. Then, the processing comes to an end.

Next, the following describes details of the interpolation processing that is executed in step S33 of FIG. 6 with reference to FIG. 7.

In step S50, the selecting block 86 of the interpolation processing block 72 outputs an input image signal supplied from the OSD superposing block 71 as an interpolated image signal. In step S51, the frame memory 81 stores the input image signal supplied from the OSD superposing block 71. In step S52, the frame memory 81 reads a preceding input image signal already stored and supplies the preceding input image signal to the detecting block 82, the moving block 83, and the mixing block 85.

In step S53, with an input image signal supplied from the OSD superposing block 71 as a target input image signal, on the basis of the target input image signal and a preceding input image signal supplied from the frame memory 81, the detecting block 82 detects a block-basis motion vector of the target input image signal.

In step S54, on the basis of the block-basis motion vector supplied from the detecting block 82, the moving block 83 moves the preceding input image signal supplied from the frame memory 81 on a block basis and supplies the moved preceding input image signal to the mixing block 85. In step S55, on the basis of the block-basis motion vector supplied from the detecting block 82, the decision block 84 determines block reliability.

In step S56, the decision block 84 determines whether the protection function is on or not and, if the protection function is found on, the decision block 84 determines in step S57 whether a total reliability is high or not on the basis of the value of the block-basis motion vector.

If the total reliability is found to be high in step S57, the decision block 84 determines, in step S58, a block-basis mixing ratio on the basis of the block reliability determined in step S55.

For example, if the block reliability is high, the decision block 84 determines the block-basis mixing ratio so that the ratio of mixing the moved preceding input image signal becomes high; if the block reliability is low, the decision block 84 determines the block-basis mixing ratio so that the ratio of mixing the moved preceding input image signal becomes low. The decision block 84 supplies the determined block-basis mixing ratio to the mixing block 85.

If the protection function is found not to be on in step S56, namely, the protection function is found to be off, then the procedure skips step S57 to step S58, in which the decision block 84 determines the mixing ratio on the basis of the block reliability as described above. Namely, if the protection function is off, the decision block 84 determines the mixing ratio on the basis of the block reliability regardless of the level of the total reliability. The decision block 84 supplies the determined mixing ratio to the mixing block 85.

In step S59, the mixing block 85 mixes a target input image signal supplied from the OSD superposing block 71 with the moved preceding input image signal supplied from the moving block 83 on the basis of the mixing ratio supplied from the decision block 84. The mixing block 85 supplies the mixed image signal to the selecting block 86 as an interpolation signal.

On the other hand, if the total reliability is found to be low in step S57, the decision block 84 supplies no-mixing information to the mixing block 85 in step S60. In step S61, in response to the no-mixing information from the decision block 84, the mixing block 85 supplies the preceding input image signal supplied from the frame memory 81 to the selecting block 86 as an interpolation signal without change.

In step S62, the selecting block 86 outputs the interpolation signal supplied from the mixing block 85 as an interpolated image signal, upon which the procedure returns to step S33 shown in FIG. 6.

It should be noted that, in the above description, the MPU 31 transmits an OSD image signal after a protection function off signal; it is also practicable to transmit an OSD image signal before a protection function off signal if the OSD superposing block 71 can start the superposition of an OSD image signal on the basis of the OSD image signal after the decision block 84 of the interpolation processing block 72 turns off the protection function in accordance with a protection function off signal.

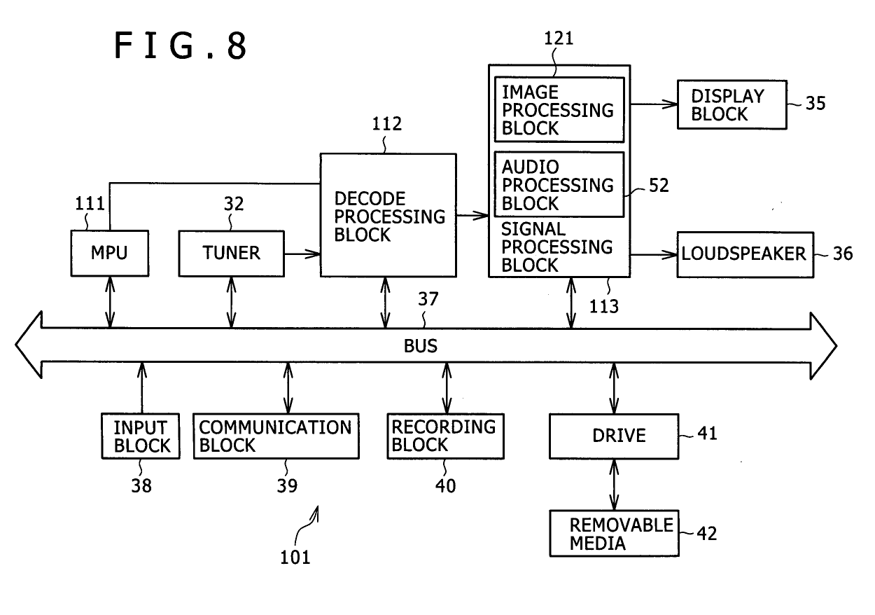

FIG. 8 shows an exemplary configuration of a second embodiment of the receiving apparatus to which the present invention is applied.

In a receiving apparatus 101, a tuner 32, an input block 38, a communication block 39, a recording block 40, a drive 41, an MPU 111, a decoding block 112, and a signal processing block 113 connected with a display block 35 and a loudspeaker 36 are interconnected via a bus 37, the decoding block 112 executing superposition. It should be noted that components similar to those previously described with reference to FIG. 1 are denoted by the same reference numerals and the description thereof will be appropriately skipped for brevity.

A port of the MPU 111 is connected to a port of decoding block 112 and MPU 111 executes communication with the decoding block 112 by controlling the port. The MPU 111 executes a program installed on the recording block 40 to execute various kinds of processing in response to commands entered from the input block 38. For example, in response to a state of the port of the decoding block 112, the MPU 111 supplies a protection function off signal to an image processing block 121 of the signal processing block 113. Also, the MPU 111 supplies a protection function on signal to the image processing block 121 via the bus 37.

Further, like the MPU 31 shown in FIG. 1, the MPU 111 controls the tuner 32, the decoding block 112, and the signal processing block 113 in response to a command for displaying a program of a user-desired channel, thereby displaying an image corresponding to a program signal of that channel onto the display block 35 and outputting sound from the loudspeaker 36.

In addition, like the MPU 31, the MPU 111 installs, as required, programs downloaded through the communication block 39 or recorded to a removable media loaded on the drive 41 onto the recording block 40.

Like the decode processing block 33 shown in FIG. 1, the decoding block 112, under the control of the MPU 111, decodes, in a predetermined method such as MPEG2, a program signal supplied from the tuner 32. Also, in response to a command for starting or ending the display of an OSD image supplied from the input block 38, the decode processing block 112 controls the port to change a port state from a normal state to a state indicative of off-state of the protection function (hereafter referred to as a protection function off state). Then, the decoding block 112 superposes an OSD image signal onto an input image signal that is an image signal of the decoded program signal and supplies the superposed input image signal to the image processing block 121.

As described above, the decoding block 112 transmits information indicative of the off-state of the protection function by changing the port states, so that the completion of the transmission need not be confirmed. Therefore, as compared with the transmission via the bus 37 that requires the confirmation of the completion of transmission, the decoding block 112 can start immediately superposing an OSD image signal upon transmission of the information indicative of the off-state of the protection function. As a result, the response of the OSD display can be faster.

The signal processing block 113 is made up of an audio processing block 52 and an image processing block 121. The image processing block 121 executes processing, such as interpolation of an image signal at an intermediate time in continuous image signals and D/A conversion, on an input image signal supplied from the decoding block 112. The image processing block 121 supplies an image signal that is an analog signal obtained as a result thereof to the display block 35 to display the image on the display block 35.

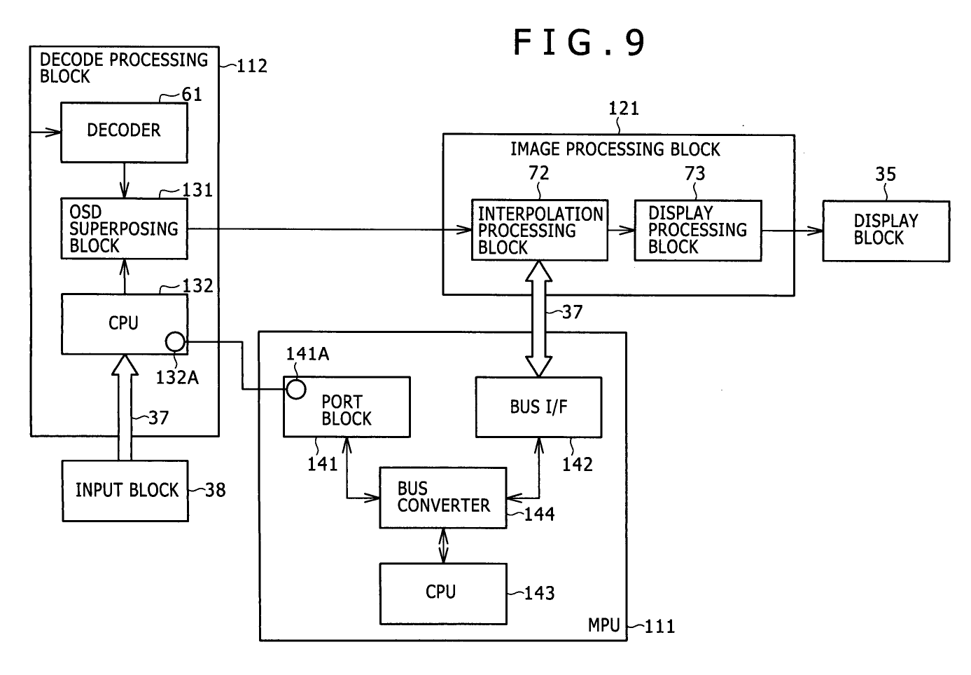

Next, the following describes interpolation that is executed in the receiving apparatus 101 shown in FIG. 8 with reference to FIG. 9.

It should be noted that, with reference to FIG. 9, components previously described with reference to FIG. 2 are denoted by the same reference numerals and the description thereof will be appropriately skipped.

A shown in FIG. 9, accepting a command of starting or ending the display of an OSD image from the user, the input block 38 supplies this command to the decoding block 112 via the bus 37.

The decoding block 112 shown in FIG. 9 is constituted by a decoder 61, an OSD superposing block 131, and a CPU (Central Processing Unit) 132. The OSD superposing block 131 stores OSD image signals. In response to a command of starting the superposition of an OSD image signals supplied from the CPU 132, the OSD superposing block 131 superposes a stored OSD image signal onto an input image signal supplied from the decoder 61 and supplies the superposed input image signal to the interpolation processing block 72. Also, in response to a command of stopping the superposition of an OSD image signal supplied from the CPU 132, the OSD superposing block 131 stops superposing the OSD image signal supplied from the decoder 61 and supplies an input image signal supplied from the decoder 61 to the interpolation processing block 72 without change.

The CPU 132 has a port 132A that is connected to a port 141A (to be described later) of the MPU 131. In response to a command of starting display of an OSD image signal supplied from the input block 38 via the bus 37, the CPU 132 controls the port 132A to change the state of the port 132A to a protection function off state, and then supplies a command of starting the superposition of an OSD image signal to the OSD superposing block 131. Also, in response to a command of ending the display of an OSD image supplied from the input block 38, the CPU 132 changes the state of the port 132A to a protection function off state and then supplies a command of stopping the superposition of the OSD image signal to the OSD superposing block 131.

In the MPU 111 shown in FIG. 9, a port block 141 having the port 141A, a bus I/F (Interface) 142, and a CPU 143 are interconnected via a bus converter 144. Under the control of the CPU 143, the port block 141 checks a state of the port 141A that is connected to the port 132A of the CPU 132. The port block 141 supplies a signal indicative of the state of this port 141A to the CPU 143 via the bus converter 144 as a state signal indicative of the state of the port 132A.

The bus I/F 142 executes communication with the image processing block 121 via the bus 37. For example, bus I/F 142 transmits a protection function off signal or a protection function on signal supplied from the CPU 143 via the bus converter 144 to the interpolation processing block 72 of the image processing block 121 via the bus 37.

As instructed by a predetermined program, the CPU 143 controls each of the port block 141 and the bus I/F 142. For example, the CPU 143 transmits a control signal for checking the state of the port 141A of the port block 141 to the port block 141 via the bus converter 144 at predetermined intervals, thereby executing polling. Also, in response to a state signal transmitted from the port block 141 via the bus converter 144 as a result of the polling, the CPU 143 supplies a protection function off signal to the bus I/F 142 via the bus converter 144. Further, the CPU 143 supplies a protection function on signal to the bus I/F 142.

The bus converter 144 is connected to the port block 141, the bus I/F 142, and the CPU 143 via a bus and controls communication among them via the bus.

The image processing block 121 is constituted by an interpolation processing block 72 and the a display processing block 73. In response to a protection function off signal or a protection function on signal supplied from the bus I/F 142 of the MPU 31 via the bus 37, the interpolation processing block 72 executes interpolation on an input image signal supplied from the OSD superposing block 131 of the decoding block 112. The interpolation processing block 72 supplies the interpolated image signal to the display processing block 73. As with the case shown in FIG. 2, on the basis of the interpolated image signal supplied from the interpolation processing block 72, the display processing block 73 displays the image on the display block 35.

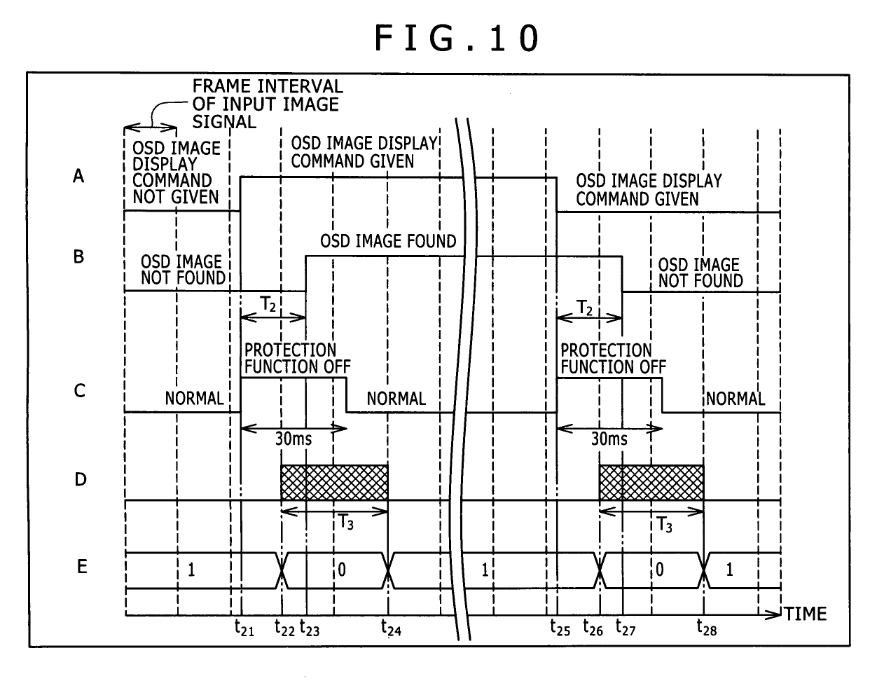

Next, referring to FIG. 10, a protection function on or off timing will be described. It should be noted that, in FIG. 10, the horizontal axis is indicative of time and it is assumed that one frame period be 1/60 second.

As shown in A of FIG. 10, when a command of starting display of an OSD image is supplied from the input block 38 to the CPU 132 of the decoding block 112 via the bus 37 at time t₂₁ in a frame period of a first input image signal, for example, from the decoder 61, the CPU 132 puts the port 132A into a protection function off state for a predetermined period as shown in C of FIG. 10.

It should be noted that, in the example shown in FIG. 10, it is assumed that an interval of polling by the CPU 143 of the MPU 111 be 10 μs. In this case, for the port block 141 to confirm a protection function off state of the port 132A, it is necessary to maintain the state of the port 132A at least for 20 μs. Therefore, in the example shown in FIG. 10, the CPU 132 keeps the port 132A in the protection function off state for 30 μs by considering also a time for interrupt handling and so on; however, the period of maintaining the protection function off state is not limited to 30 μs as long as the port block 141 can confirm the protection function off state of the port 132A in a period of time (20 μs or longer in the example of FIG. 10).

Next, the CPU 143 of the MPU 111 controls the port block 141 to execute polling at intervals of 10 μs, thereby getting a state signal indicative of a protection function off state from the port block 141. In response to this state signal indicative of a projection function off state, the CPU 143 transmits a protection function off signal to the decision block 84 of the interpolation processing block 72 at time t₂₂ when a second input image signal of a frame next to the first input image signal is entered in the interpolation processing block 72.

As a result, as shown in E of FIG. 10, the decision block 84 of the interpolation processing block 72 turns off the projection function when the second input image signal becomes a target input image signal. It should be noted that, in E of FIG. 10, an on-state of the protection function is expressed in “1” and an off-state of the protection function is expressed in “0.”

After passing of predetermined period T₂ after changing of the state of the port 132A to the protection function off state, the CPU 132 supplies a command for starting the superposition of an OSD image signal to the OSD superposing block 131. Consequently, in the example shown in FIG. 10, the superposition of the OSD image signal starts from time t₂₃ in the frame period of the second input image signal supplied from the decoder 61.

As described above, the detecting block 82 of the interpolation processing block 72 detects a block-basis motion vector on the basis of a target input image signal and a preceding input image signal, so that, as shown in D of FIG. 10, it is possibly determined that the total reliability is low in period T₃ that is equivalent to two frames from time t₂₂ when the second input image signal on which the superposition of an OSD image signal started becomes a target input image signal to time t₂₄ when a 4th input image signal two frames after the second input image signal on which the superposition of an OSD image signal was executed also on an input image signal one frame before from the start of the frame period becomes a target input image signal.

Therefore, the CPU 143 of the MPU 111 enters a protection function off signal into the interpolation processing block 72 at time t₂₂ and enters a protection function on signal into the interpolation processing block 72 at time t₂₄ after passing of period T₃ from time t₂₂, thereby setting off the protection function for period T₃ as shown in E of FIG. 10. Consequently, even if the total reliability is determined low by an OSD image signal, the interpolation by a motion vector is executed, thereby suppressing the jerk in image to enhance the picture quality of interpolated images.

It should be noted that, like period T₁, the length of period T₃ depends on the performance of the OSD superposing block 131 and the detection method of the detecting block 82 and is set accordingly.

Next, as shown in A of FIG. 10, when a command for ending displaying of the OSD image is supplied from the input block 38 to the CPU 132 via the bus 37 at time t₂₅ in the frame period of the 11th input image signal for example supplied from the decoder 61, the same processing as that of OSD image display start is executed. To be more specific, as shown in C of FIG. 10, the CPU 132 keeps the port 132A in a protection function off state for 30 μs.

As a result, the protection function off state of the port 132A is confirmed by the polling by the CPU 143 at intervals of 10 μps, by which the decision block 84 of the interpolation processing block 72, as shown in E of FIG. 10, turns off the protection function from time t₂₆ when the 12th input image signal of a frame next to the 11th input image signal becomes a target input image signal.

After passing of predetermined period T₂ after changing of the state of the port 132A to the protection function off state, the CPU 132 supplies a command of stopping the superposition of an OSD image signal to the OSD superposing block 131. Consequently, in the example shown in FIG. 10, the superposition of the OSD signal is stopped from time t₂₇ in the frame period of the 12th input image signal supplied from the decoder 61.

As described above, the superposition is stopped at time t₂₇ in the frame period of the 12th input image signal supplied from the decoder 61, so that it is possibly determined that the total reliability is low during period T₃ that is equivalent to two-frame periods from time t₂₇ when the 12th input image signal becomes a target input image signal to time t₂₈ when the 14th input image signal two frames after the 12th input image signal becomes a target input image signal.

Therefore, the CPU 143 enters a protection function off signal into the interpolation processing block 72 at time t₂₆ and enters a protection function on signal into the interpolation processing block 72 at time after passing of period T₃ from time t₂₂, thereby setting off the protection function for period T₃ as shown in E of FIG. 10. Consequently, if the total reliability is determined low by an OSD image signal, the interpolation by a motion vector is executed, thereby enhancing the picture quality of interpolated images.

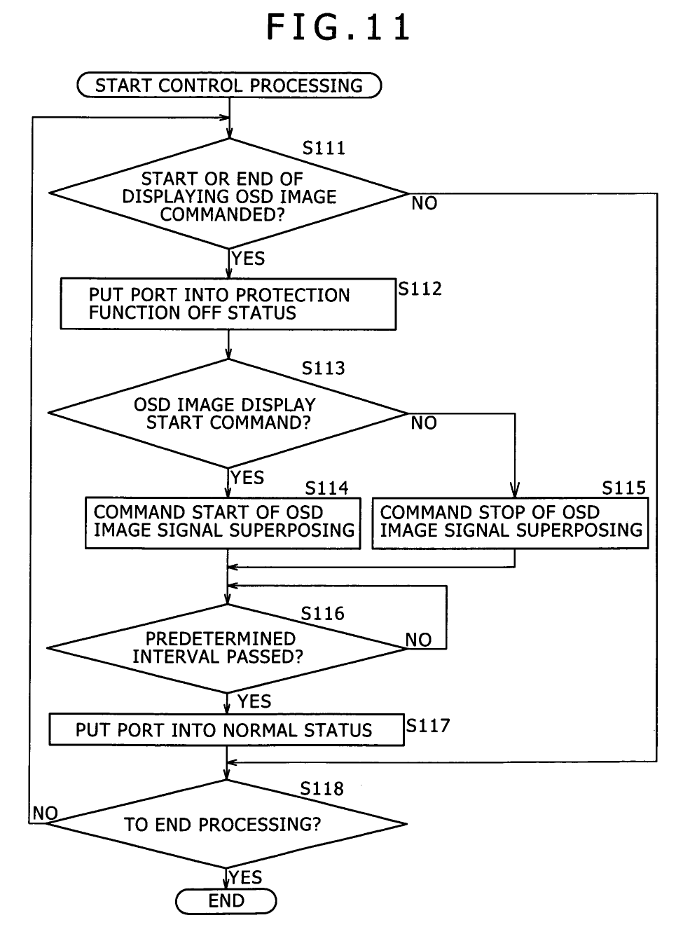

Next, with reference to FIG. 11, control processing that is executed in the receiving apparatus 101 shown in FIG. 8 will be described. This control processing starts when the receiving apparatus 101 is powered on, for example.

In step S111, the CPU 132 of the decoding block 112 determines whether an OSD image display start or end command has been given from the input block 38. If an OSD image display start or end command is found not given, then the procedure skips steps S112 through S117 to step S118.

On the other hand, if an OSD image display start or end command is found given in step S111, the CPU 132 sets the state of the port 132A to the protection function off state in step 112. In step S113, the CPU 132 determines whether the command determined in step S111 is a command for starting the display of an OSD image or not.

If the command is found to be the start of the display of an OSD image in step S113, the CPU 132 commands the OSD superposing block 131 to start the superposition of an OSD image in step S114. On the other hand, if the command is found not to be the starting of the display of an OSD image, namely, the command is found to be the ending of the display of an OSD image, the CPU 132 commands the OSD superposing block 131 to stop the superposition of an OSD image signal in step S115.

After the process of step S114 or step S115, the CPU 132 determines in step S116 whether a predetermined period (30 μs in the example shown in FIG. 10) has passed since the state of the port 132A was put in the protection function off state in step S112. If a predetermined period is found not passed in step S116, the CPU 132 waits until the predetermined period passes. If a predetermined period is found passed in step S116, the CPU 132 puts the state of the port 132A into the normal state in step S117.

In step S118, the CPU 132 determines whether to stop the processing, or whether a power off command has come from the input block 38, for example. If the processing is found not to be stopped in step S118, the procedure returns to step S111 to repeat the above-mentioned processing. On the other hand, if the processing is found to be stopped in step S118, the processing comes to an end.

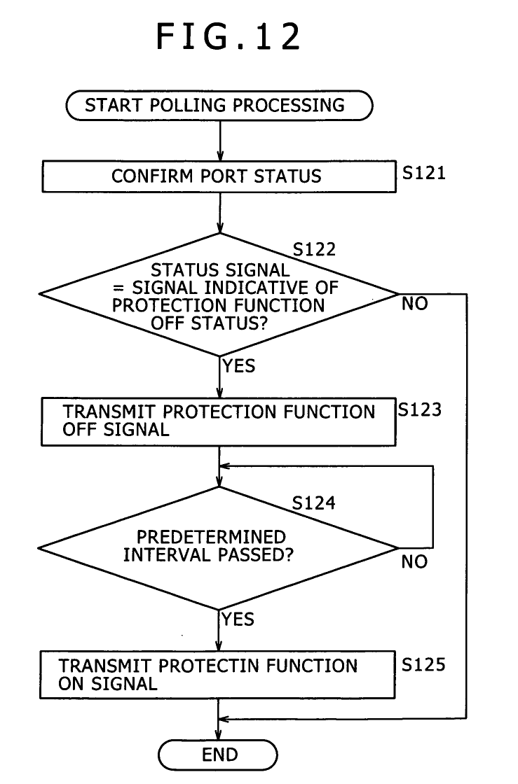

Next, with reference to FIG. 12, the polling processing that is executed in the CPU 143 of the MPU 111 shown in FIG. 9 will be described. This polling processing starts at predetermined intervals (10 μs in the example of FIG. 10).

In step S121, under the control of the CPU 143, the port block 141 confirms a state of the port 141A connected to the port 132A of the CPU 132. The port block 141 supplies a state signal indicative of that state to the CPU 143 via the bus converter 144 as a state signal indicative of the state of the port 132A.

In step S122, the CPU 143 determines whether the state signal supplied from the port block 141 is a signal indicative of a protection function off state and, if the signal is found to be indicative of a protection function off state, supplies a protection function off signal to the bus I/F 142 via the bus converter 144.

In step S123, the bus I/F 142 transmits the protection function off signal to the interpolation processing block 72 via the bus 37. In step S124, the CPU 143 determines whether predetermined period T₃ has passed since the transmission of the protection function off signal in step S123 and, if predetermined period T₃ is found not passed, waits until predetermined period T₃ passes.

If predetermined period T₃ is found passed in step S124, the CPU 143 supplies a protection function on signal to the bus I/F 142 via the bus converter 144. In step S125, the bus I/F 142 transmits the protection function on signal to the interpolation processing block 72 via the bus 37 to end the processing.

On the other hand, if the state signal is found to be not a signal indicative of a protection function off state, namely, the state signal is found to be a signal indicative of a normal state, the processing comes to an end.

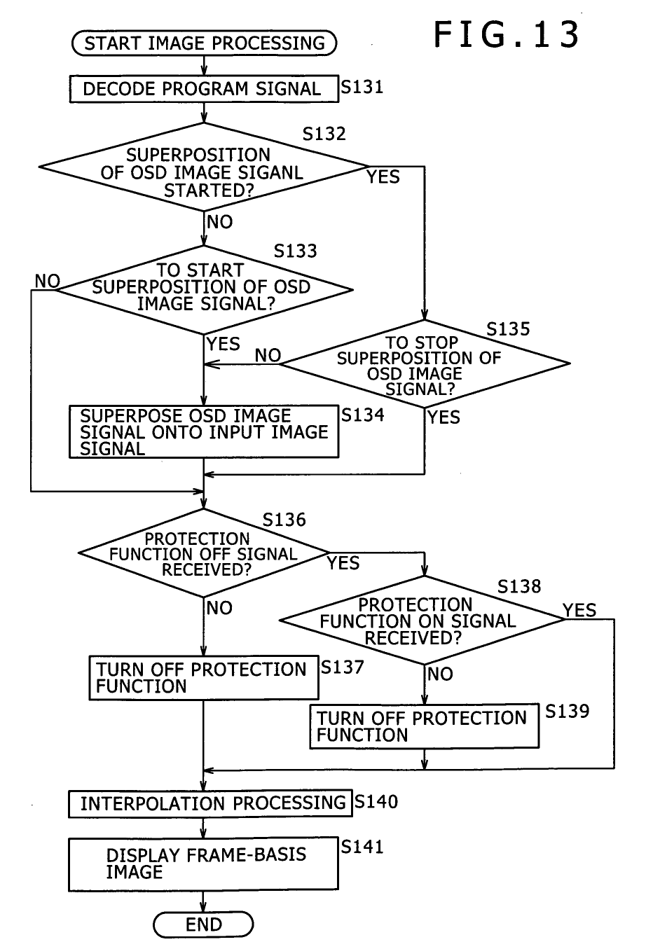

Next, with reference to FIG. 13, the image processing that is executed in the receiving apparatus 101 shown in FIG. 8 will be described. This image processing starts when a program signal is entered in the decoding block 112, for example.

In step S131, the decoder 61 decodes a program signal and supplies an image signal obtained as result thereof to the OSD superposing block 131 as an input image signal and supplies an audio signal to the audio processing block 52. In step S132, the OSD superposing block 131 determines whether the superposition of an OSD image signal has already started or not and, if the superposition of an OSD image signal is found not started, the procedure goes to step S133.

In step S133, the OSD superposing block 131 determines whether to start the superposition of an OSD image signal or not, namely, the starting of the superposition of an OSD image signal was commanded by the CPU 132 in step S114 shown in FIG. 11. If the starting of the superposition of an OSD image signal is found commanded in step S133, then the OSD superposing block 131 superposes an OSD image signal onto the input image signal in step S134 and supplies the superposed input image signal to the interpolation processing block 72 of the image processing block 121. Then, the procedure goes to step S136.

On the other hand, if the superposition of an OSD image signal is found started in step S132, the OSD superposing block 131 determines in step S135 whether to stop the superposition of the OSD image signal, namely, the stopping of the superposition of the OSD image signal was commanded by the CPU 132 in step S115 shown in FIG. 11. If the superposition of the OSD image signal is found to be stopped in step S135, the procedure goes to step S136.

Also, if the superposition of the OSD image signal is found not to be stopped in step S135, the OSD superposing block 131 superposes the OSD image signal onto the input image signal in step S134 as described above.

Further, if the superposition of the OSD image signal is found not to be started in step S133, the procedure goes to step S136. In step S136, the decision block 84 determines whether the protection function off signal transmitted from the bus I/F 142 via the bus 37 in step S123 in FIG. 12 has been received or not. If the protection function off signal is found received in step S136, the decision block 84 turns off the protection function in step S137 and the procedure goes to step S140.

Also, if the protection function off signal is found not received in step S136, the decision block 84 determines in step S138 whether a protection function on signal transmitted from the bus I/F 142 in step S125 in FIG. 12 has been received or not. If a protection function on signal is found received in step S138, the decision block 84 turns on the protection function in step S139 and the procedure goes to step S140. On the other hand, if a protection function on signal is found not received in step S138, the procedure goes to step S140 without changing the protection function.

In step S140, the interpolation processing block 72 executes the interpolation processing shown in FIG. 7. In step S141, the display processing block 73 executes D/A conversion on the interpolated image signal supplied from the interpolation processing block 72 and supplies an image signal that is an analog signal obtained as a result thereof to the display block 35 to display the frame-basis image on the display block 35. Then, the processing comes to an end.

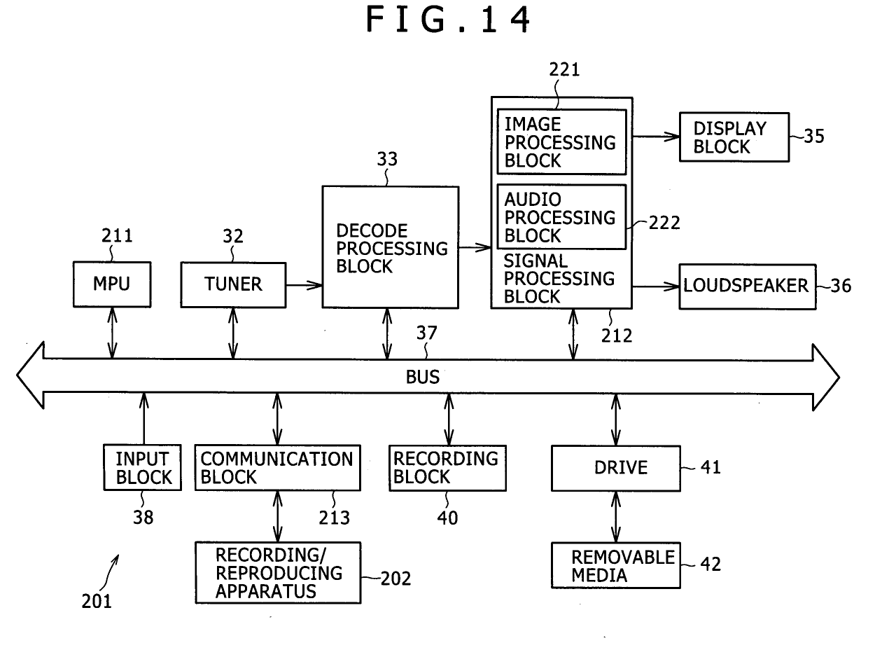

FIG. 14 shows an exemplary configuration of a third embodiment of a receiving apparatus to which the present invention is applied.

In a receiving apparatus 201 shown in FIG. 14, a tuner 32, a decode processing block 33, an input block 38, a recording block 40, a drive 41, an MPU 211, a signal processing block 212 connected with a display block 35 and a loudspeaker 36, and a communication block 213 are interconnected via a bus 37 and an external recording/reproducing apparatus 202 connected to the receiving apparatus 201 executes superposition. It should be noted that components similar to those previously described with reference to FIGS. 1 and 8 are denoted by the same reference numerals and the description thereof will be appropriately skipped for brevity.

For example, by executing a program installed on the recording block 40, the MPU 211 executes various kinds of processing in response to commands or the like entered through the input block 38. For example, like the MPU 31, the MPU 211 controls the tuner 32, the decode processing block 33, and the signal processing block 34 in response to a command for displaying a program of a user-desired channel to display an image corresponding to the program signal of that channel onto the display block 35 and output sound from the loudspeaker 36.

Also, in response to an OSD start signal indicative of the starting of the superposition of an OSD image or an OSD end signal indicative of the ending of the superposition of an OSD image supplied from the communication block 213, the MPU 211 supplies a protection function off signal to an image processing block 221. In addition, the MPU 211 supplies a protection function on signal to the image processing block 221. Also, the MPU 211 installs programs downloaded from the communication block 213 and programs recorded to a removable media 42 loaded on the drive 41 into the recording block 40 as needed.

The signal processing block 212 is constituted by the image processing block 221 and an audio processing block 222. The image processing block 221 executes processing such as interpolation on an image signal at an intermediate time of continuous image signals and D/A conversion onto an input image signal supplied from the decode processing block 33 or an image signal (thereafter referred to as a received image signal) of program signals supplied from the communication block 213. The signal processing block 212 supplies an image signal that is an analog signal obtained as a result thereof to the display block 35 to display the image on the display block 35.

The audio processing block 222 executes D/A conversion and so on onto an audio signal of the program signal supplied from the decode processing block 33 or the communication block 213 and supplies an audio signal that is an analog signal obtained as a result thereof to the loudspeaker 36 to output sound outside.

The communication block 213, connected to the external recording/reproducing apparatus 202, executes communication with the recording/reproducing apparatus 202. For example, the communication block 213 receives an OSD start signal or an OSD end signal from the recording/reproducing apparatus 202 and supplies the OSD start signal or the OSD end signal to the image processing block 221 of the signal processing block 212 via the bus 37. Also, the communication block 213 receives a program signal from the recording/reproducing apparatus 202 and supplies the program signal to the signal processing block 212. Further, like the communication block 39 shown in FIG. 1 and FIG. 8, the communication block 213 transmits and receives various kinds of data via a network such as the Internet, not shown. For example, the communication block 213 downloads a predetermined program from a server, not shown, via a network and supplies the predetermined program to the MPU 211.

The recording/reproducing apparatus 202 is constituted by a DVD (Digital Versatile Disc) recorder, a hard disk recorder or the like, for example. The recording/reproducing apparatus 202 receives a radio wave of a program signal of a user-desired program and records this program signal to a recording media such as a DVD or a hard disk drive. The recording/reproducing apparatus 202 reproduces a recorded program signal as instructed by the user for reproduction and transmits the program signal to the communication block 213.

Also, in response to a command for starting or ending the display of an OSD image by the user, the recording/reproducing apparatus 202 transmits an OSD start signal or an OSD end signal to the communication block 213. After transmitting an OSD start signal, the recording/reproducing apparatus 202 superposes an OSD image signal onto an image signal of the reproduced program signal and transmits the program signal obtained as a result thereof to the communication block 213.

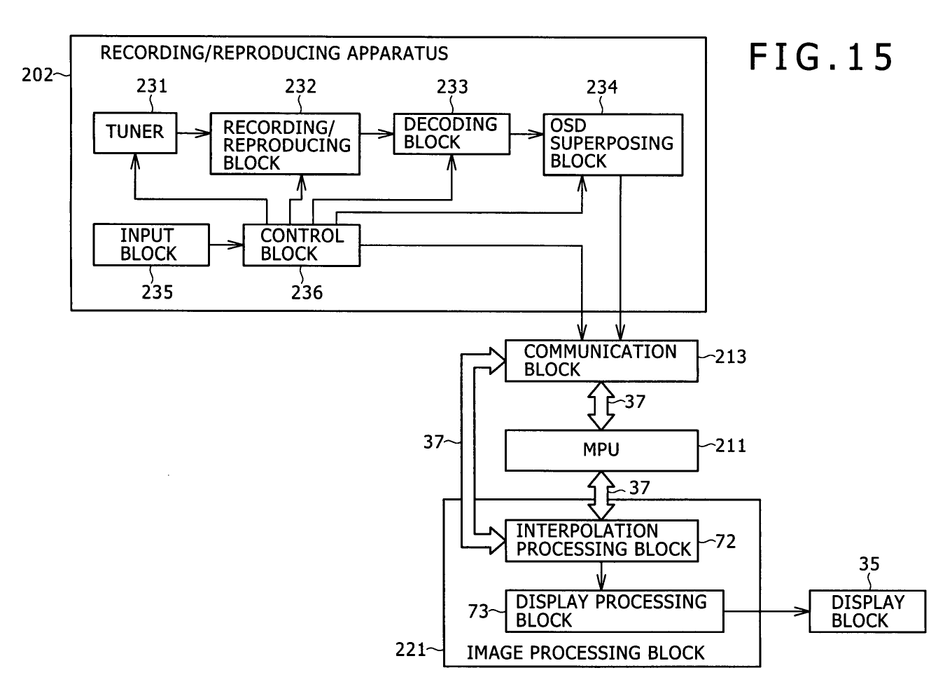

Next, with reference to FIG. 15, the interpolation that is executed in the receiving apparatus 201 shown in FIG. 14 will be described.

It should be noted that, in FIG. 5, components similar to those shown in FIG. 2 and FIG. 9 are denoted by the same reference numerals and the description thereof will be appropriately skipped for brevity.

The recording/reproducing apparatus 202 shown in FIG. 15 has a tuner 231, a recording/reproducing block 232, a decoding block 233, an OSD superposing block 234, input block 235, and a control block 236.

Under the control of the control block 236, the tuner 231 receives a radio wave of a program signal radiated from a broadcasting station, not shown, and demodulates the radio wave. The tuner 231 supplies a program signal obtained as a result of the demodulation to the recording/reproducing block 232 for recording.

The recording/reproducing block 232 records the program signal supplied from the tuner 231 to a removable media such as a DVD loaded thereon and a recording media (not shown) such as an incorporated hard disk drive. The recording/reproducing block 232 reads the recorded program signal under the control of the control block 236 and supplies the program signal to the decoding block 233.

Under the control of the control block 236, the decoding block 233 decodes, in a predetermined method, the program signal supplied from the recording/reproducing block 232 and supplies a program signal obtained as a result thereof to the OSD superposing block 234.

The OSD superposing block 234 superposes an OSD image signal supplied from the control block 236 onto an image signal of the program signal supplied from the decoding block 233. The OSD superposing block 234 transmits the program signal obtained as a result thereof or the program signal itself supplied from the decoding block 233 to the communication block 213 of the receiving apparatus 201 by communication via a SCART terminal, HDMI (High-Definition Multimedia Interface) communication or the like.

The input block 235 is constituted by, for example, a receiving block for receiving commands transmitted from a remote controller, not shown, buttons, a keyboard, a mouse, switches and the like thereby accepting user commands. The input block 235 supplies various commands to the control block 236 in response to commands given by the user.

For example, in response to a command for recording or reproducing a program of a user-desired channel, the input block 235 supplies a command for recording or reproducing this program to the control block 236. Also, in response to a command for starting or ending the display of an OSD image from the user, the input block 235 supplies a command for starting or ending the display of an OSD image to the control block 236.

In response to the command or the like entered through the input block 235, the control block 236 executes various kinds of processing. For example, in response to a command for recording a program of a user-desired channel, the control block 236 controls the tuner 231 to record the program signal of that program to the recording/reproducing block 232. Also, in response to a command for reproducing a program of a user-desired channel, the control block 236 controls the recording/reproducing block 232 and the decoding block 233 to reproduce the program signal of that program from the recording/reproducing block 232.

Further, in response to a command for starting the display of an OSD image, the control block 236 transmits an OSD start signal to the communication block 213 by such as an AV link (AV Link) specified as EN-50157 in CEC line (Consumer Electronics Control Line) of HDMI communication and CENELEC (European Committee for Electrotechnical Standardization) and then supplies an OSD image signal to the OSD superposing block 234. Also, in response to a command for ending the display of an OSD image, the control block 236 transmits an OSD end signal to the communication block 213 by the CEC line of HDMI communication or AV link and then commands the OSD superposing block 234 to stop superposing an OSD image signal.

The communication block 213 receives an OSD start signal or an OSD end signal from the control block 236 and supplies the received signal to the MPU 211 via the bus 37. Also, the communication block 213 receives a program signal from the OSD superposing block 234 and supplies a received image signal of the program signal to the interpolation processing block 72 of the image processing block 121 and supplies an audio signal to the audio processing block 222. In response to the OSD start signal or the OSD end signal, the MPU 211 supplies a protection function off signal to the interpolation processing block 72. Also, the MPU 211 supplies a protection function on signal to the interpolation processing block 72.

It should be noted that, although not shown, a protection function on or off timing in the receiving apparatus 201 is the same as shown in FIG. 4. Namely, as shown in A of FIG. 4, when a command is given from the input block 235 to the control block 236, the superposition in the OSD superposing block 234 is executed as shown in B of FIG. 4. As a result, in the receiving apparatus 201, as shown in C of FIG. 4, it may be determined that the total reliability is low in a predetermined frame, so that, as shown in D of FIG. 4, the protection function is off during predetermined period T₁.

As described above, the recording/reproducing apparatus 202 transmits an OSD start signal or an OSD end signal to the receiving apparatus 201 before starting or ending the superposition of an OSD image signal, so that the receiving apparatus 201 turns off the protection function in response to the OSD start signal or the OSD end signal, therefore the interpolation based on a motion vector can be executed even if the total reliability is determined low by an OSD image signal. Therefore, the picture quality of the interpolated image can be enhanced.

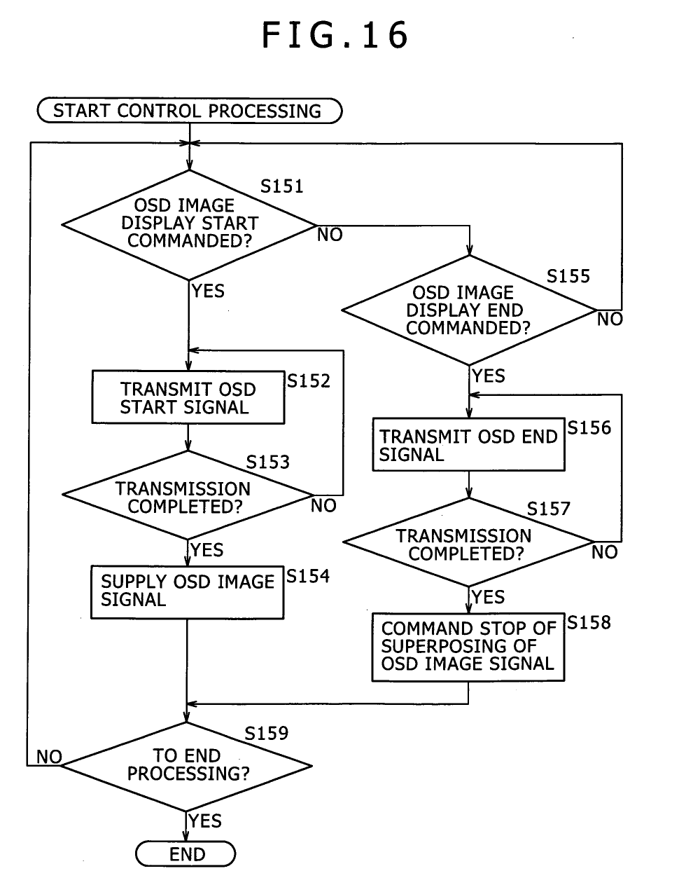

Next, with reference to FIG. 16, the control processing that is executed in the receiving apparatus 201 shown in FIG. 14 will be described. This control processing starts when the receiving apparatus 201 is powered on, for example.

In step S151, the control block 236 determines whether the starting of display of an OSD image has been commanded from the input block 235. If the starting of display of an OSD image is found commanded in step S151, the control block 236 transmits an OSD start signal to the communication block 213 of the receiving apparatus 201 in step S152. In step S153, the control block 236 determines whether the transmission has been completed or not, namely, information indicative of the normal reception has been transmitted or not from the communication block 213 in response to the transmission of step S152.

If the transmission is found not completed in step S153, the procedure returns to step S152 and repeatedly transmits an OSD start signal until the transmission is found completed in step S153. If the transmission is found completed in step S153, the control block 236 supplies an OSD image signal to the OSD superposing block 234 in step S154.

On the other hand, if the starting of display of an OSD image is fount not commanded in step S151, the control block 236 determines in step S155 whether the ending of display of an OSD image has been commanded from the input block 235. If the ending of display of an OSD image is found not commanded in step S155, the procedure returns to step S151 to repeat the above-mentioned processing.

If the ending of display of an OSD image is found commanded in step S155, the control block 236 transmits an OSD end signal to the communication block 213 in step S156. In step S157, the control block 236 determines whether the transmission has been completed or not and, if the transmission is found not completed, the procedure returns to step S156 to repeatedly transmit an OSD signal until the transmission is found completed in step S157. If the transmission is found completed in step S157, the control block 236 commands the OSD superposing block 234 to stop the superposition of an OSD image signal in step S158.

After the process of step S154 or S158, the control block 236 determines in step S159 whether to end the processing, a power-off command has come from the input block 235, for example. If the processing is found not to be ended in step S159, the procedure goes back to step S151 to repeat the above-mentioned processing. On the other hand, if the processing is found to be ended in step S159, the processing comes to an end.

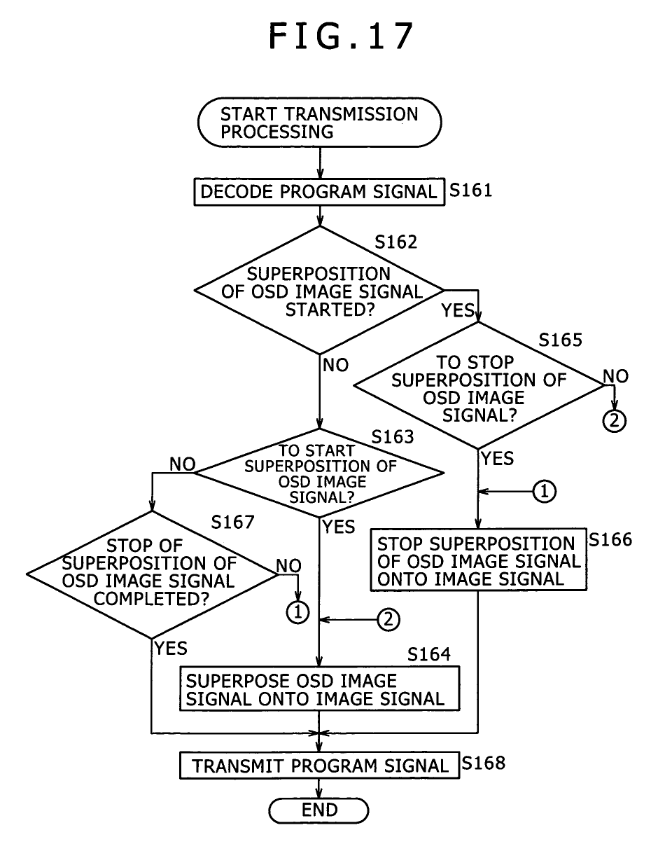

Next, with reference to FIG. 17, the transmission processing that is executed in the recording/reproducing apparatus 202 will be described. This transmission processing starts when a program signal reproduced from the recording/reproducing block 232 is entered in the decoding block 233, for example.

In step S161, the decoding block 233 decodes a program signal entered from the recording/reproducing block 232 and supplies a program signal obtained as a result thereof to the OSD superposing block 234. In step S162, the OSD superposing block 234 determines whether the superposition of an OSD image signal has already started or not and, if the superposition of an OSD image signal is found not yet started, the procedure goes to step S163.

In step S163, the OSD superposing block 234 determines whether to start the superposition of an OSD image signal, namely, an OSD image signal has been supplied from the control block 236 in step S154 of FIG. 16. If the superposition of an OSD image signal is found to be started in step S163, the OSD superposing block 234 superposes, in step S164, the obtained OSD image signal onto an image signal of the program signal supplied from the decoding block 233 and the procedure goes to step S168.

On the other hand, if the superposition of an OSD image signal is found already started in step S162, the OSD superposing block 234 determines in step S165 whether to stop the superposition of an OSD image signal, namely, the stopping of the superposition of OSD image signal has been commanded by the control block 236 in step S158 of FIG. 16. If the superposition of an OSD image signal is found to be stopped in step S165, the OSD superposing block 234 gradually stops, in step S166, the superposition of an OSD image signal on the image signal of the program signal supplied from the decoding block 233 and the procedure goes to step S168.

Also, if the superposition of an OSD image signal is found not to be stopped in step S165, the OSD superposing block 234 superposes the obtained OSD signal on the image signal in step S164 as described above and the procedure goes to step S168.

Further, if the superposition of an OSD signal is found not to be started in step S163, the OSD superposing block 234 determines in step S167 whether the stopping of the superposition of an OSD image signal has been completed, namely, no OSD image signal has been superposed on the previous image signal.

If the stopping of the superposition of an OSD image signal is found not completed in step S167, the OSD superposing block 234 gradually stops the superposition of an OSD image signal onto the image signal in step S166 as described above and the procedure goes to step S168.

On the other hand, if the stopping of the superposition of an OSD image signal is found completed in step S167, the procedure goes to step S168. The OSD superposing block 234 transmits, in step S168, a program signal containing one of the superposed image signal, the image signal with superposition gradually stopped, and the image signal not superposed to the communication block 213 of the receiving apparatus 201, upon which the processing comes to an end.

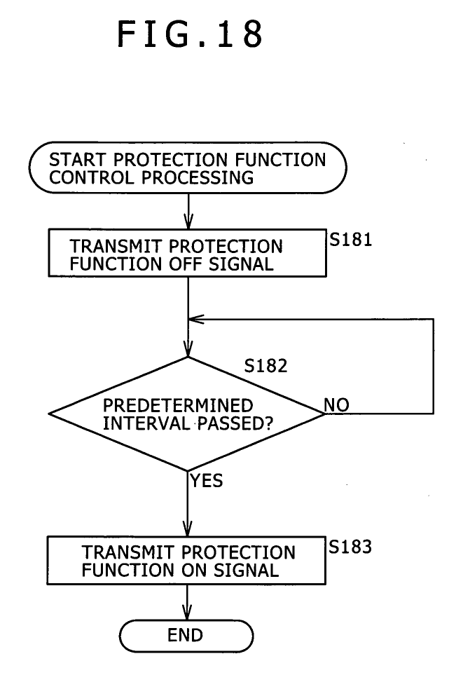

Next, with reference to FIG. 18, the protection function control processing that is executed in the MPU 211 of the receiving apparatus 201 will be described. This protection function control processing starts when an OSD start signal transmitted in step S152 of FIG. 16 or an OSD end signal transmitted in step S156 is supplied to the MPU 211 via the communication block 213, for example.

In step S181, the MPU 211 transmits a protection function off signal to the decision block 84 of the interpolation processing block 72 via the bus 37. In step S182, the MPU 211 determines whether predetermined period T₁ has passed since the transmission of the protection function off signal in step S181. If predetermined period T₁ is found not passed in step S182, the MPU 211 waits until predetermined period T₁ passes. If predetermined period T₁ is found passed in step S182, the MPU 211 transmits a protection function on signal to the decision block 84 via the bus 37 in step S183.

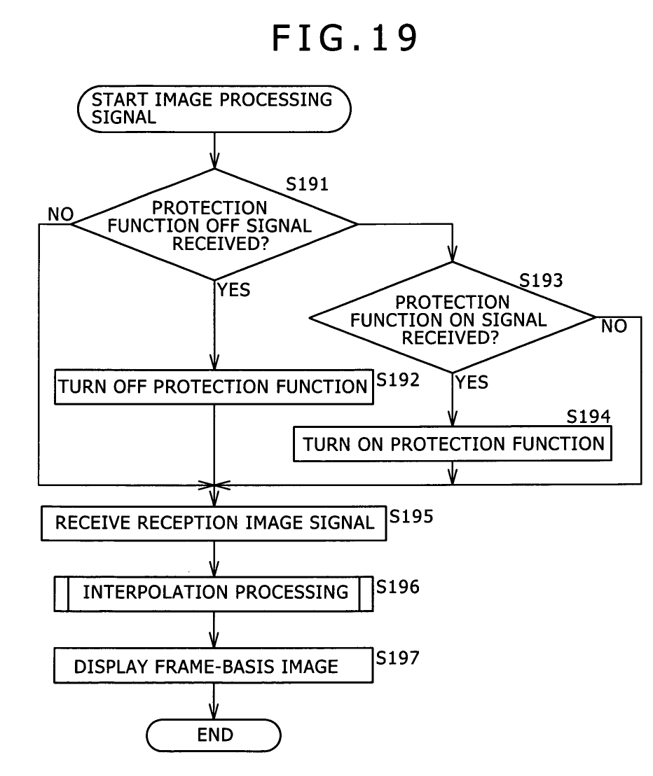

Next, with reference to FIG. 19, the image processing that is executed in the image processing block 221 will be described. This image processing starts when the receiving apparatus 201 is powered on, for example.

In step S191, the decision block 84 of the interpolation processing block 72 determines whether a protection function off signal transmitted from the MPU 211 in step S181 of FIG. 18 has been received or not. If the protection function off signal is found received in step S191, the decision block 84 turns off the protection function in step S192 and the procedure goes to step S195.

Also, if the protection function off signal is found not received in step S191, the decision block 84 determines in step S193 whether a protection function on signal transmitted from the MPU 211 has been received or not in step S183 of FIG. 18. If the protection function on signal is found received in step S193, the decision block 84 turns on the protection function in step S194 and the procedure goes to step S195. On the other hand, if the protection function on signal is found not received in step S193, the protection function is not changed and the procedure goes to step S195.

In step S195, the communication block 213 receives an image signal transmitted from the OSD superposing block 234 in step S168 shown in FIG. 17 as a received image signal and supplies the received image signal to the interpolation processing block 72 via the bus 37. In step S196, the interpolation processing block 72 executes interpolation processing shown in FIG. 7 on the received image signal.

In step S197, the display processing block 73 executes D/A conversion on the interpolated image signal supplied from the interpolation processing block 72 and supplies an image signal that is an analog signal obtained as a result thereof to the display block 35 to display a frame-basis image on the display block 35. Then, the processing comes to an end.

It should be noted that, in the above description, the protection function is turned off for predetermined period T₁ (T₃) at the starting and ending of the superposition of an OSD image signal; however, it is also practicable to turn off the protection function for a predetermined period at a cursor movement in an OSD image, for example.

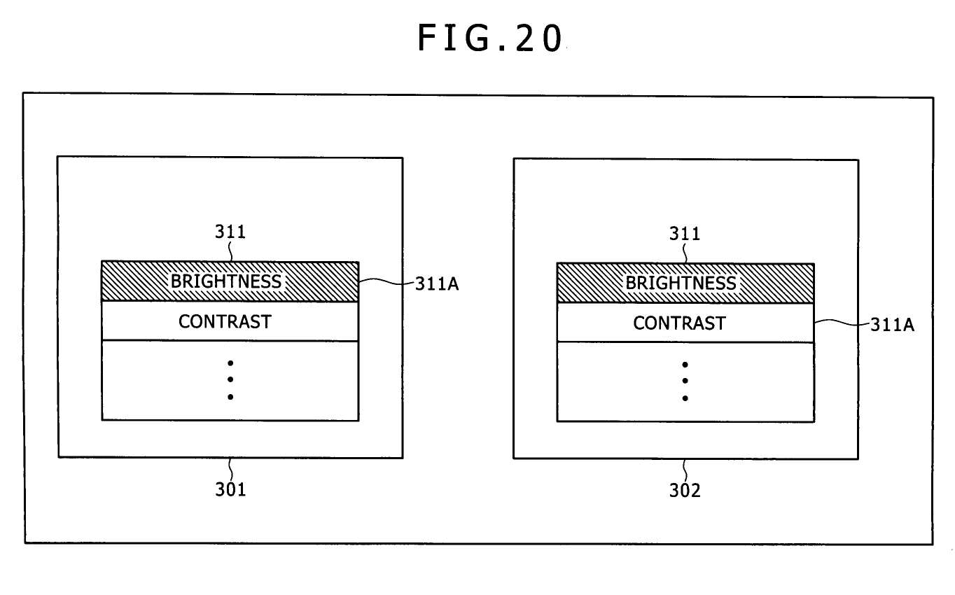

Namely, as shown in FIG. 20, if an OSD image 311 of a menu having items “brightness,” “contrast,” . . . etc. is superposed on an image 301 of a preceding input image signal and a cursor 311A is superposed on the item “brightness” and, when the cursor 311A is moved to item “contrast” in an image 302 of a target input image signal of a next frame, a motion vector having a low total reliability may be detected by determining that the cursor 311A newly appeared in the image 302 as a result of the movement of the cursor 311A.

Therefore, in response to a command for moving the cursor 311A from the input block 38 (235), the receiving apparatus 11 (101, 201) turns off the protection function for a predetermined period to suppress a jerk in image, thereby enhancing the picture quality of the interpolated image signal.

Also, in the above description, a image signal at an intermediate time between continuous image signals is interpolated; it is also practicable to interpolate an image signal at an arbitrary time other than an intermediate time.

Further, in the above description, the protection function is set for all screens; it is also practicable to set the protection function for each predetermined area. In this case, when the protection function is on, the reliability of the area to which the protection function is set determines to execute or not to execute the interpolation of a motion vector for each area.

It should be noted in the specification that the steps for describing each program recorded in recording media include not only the processing operations which are sequentially executed in a time-dependent manner but also the processing operations which are executed concurrently or discretely.

In addition, the embodiments of the present invention are not limited to the embodiments described above, and it is to be understood that changes and variations may be made without departing from the spirit of the present invention.

1. An image processing apparatus comprising:
detecting means for detecting a motion vector of an input image signal that is an entered time-series image signal;
determining means for determining a level of a reliability of said motion vector;
interpolating means for interpolating and outputting, if the reliability of said motion vector is high, on the basis of said motion vector, a signal between input image signals that is an image signal at a given time between said input image signal and a preceding input image signal that is an input image signal one before the input image signal and, if the reliability of said motion vector is low, outputting said preceding input image signal as said signal between input image signals without change; and
accepting means for accepting a command for starting or ending superposition of a predetermined image signal onto said input image signal,
wherein, if the command for starting or ending said superposition is accepted, said detecting means detects a motion vector of said input image signal with the superposition of said predetermined image signal started or ended and,
if the command for starting or ending said interpolation is accepted, said interpolating means interpolates and outputs said signal between input image signals regardless of the reliability of said motion vector and on the basis of said motion vector.

2. The image processing apparatus according to claim 1, further comprising
superposing means for starting or ending, if a command for starting or ending the superposition is accepted, the superposition of said predetermined image signal onto said input image signal.

3. The image processing apparatus according to claim 1, wherein said determining means, if a value of said motion vector is smaller than a threshold value, determines that said reliability is high and, if a value of said motion vector is greater than a threshold value, determines that said reliability is low.

4. The image processing apparatus according to claim 1, wherein said determining means determines on the basis of a difference between said input image signal and said preceding input image signal, whether said input image signal is an image signal at a time of scene change and, if said input image signal is found to be not an image signal at a time of scene change, determines that said reliability is high and, if said input image signal is found to be an image signal at a time of scene change, determines that said reliability is low.

5. The image processing apparatus according to claim 1, wherein
said accepting means and said interpolating means are interconnected via a bus;
said accepting means, upon accepting the command for starting or ending said superposition, transmits a stop signal indicative of stopping of suppression of interpolation by said interpolating means to said interpolating means before said interpolation is started or ended via said bus; and
said interpolating means, upon receiving said stop signal transmitted from said accepting means, interpolates and outputs said signal between input image signals on the basis of said motion vector regardless of the reliability of said motion vector.

6. The image processing apparatus according to claim 1, wherein
said accepting means, upon accepting the command for starting or ending said superposition, puts a port into a state indicative of stopping suppression of the interpolation by said interpolating means before said superposition is started or ended; and
said interpolating means confirms the state of said port by polling before said superposition is started or ended and, if the state of said port is indicative of stopping of suppression of the interpolation by said interpolating means, interpolates and outputs said signal between input image signals on the basis of said motion vector regardless of the reliability of said motion vector.

7. An image processing method for an information processing apparatus configured to detect a motion vector of an input image signal that is an entered time-series image signal, determine a level of a reliability of said motion vector, interpolate and output, if the reliability of said motion vector is high, on the basis of said motion vector, a signal between input image signals that is an image signal at a given time between said input image signal and a preceding input image signal that is an input image signal one before the input image signal, and, if the reliability of said motion vector is low, output said preceding input image signal as said signal between input image signals without change, said image processing method comprising the steps of:
accepting a command for starting or ending superposition of a predetermined image signal onto said input image signal;
if the command for starting or ending said superposition is accepted, detecting a motion vector of said input image signal with the superposition of said predetermined image signal started or ended; and
if the command for starting or ending said superposition is accepted, interpolating and outputting said signal between input image signals on the basis of said motion vector regardless of the reliability of said motion vector.

8. A program for making a computer execute image processing for detecting a motion vector of an input image signal that is an entered time-series image signal, determining a level of a reliability of said motion vector, interpolating and outputting, if the reliability of said motion vector is high, on the basis of said motion vector, a signal between input image signals that is an image signal at a given time between said input image signal and a preceding input image signal that is an input image signal one before the input image signal, and, if the reliability of said motion vector is low, outputting said preceding input image signal as said signal between input image signals without change, said program comprising the steps of:
accepting a command for starting or ending superposition of a predetermined image signal onto said input image signal;
if the command for starting or ending said superposition is accepted, detecting a motion vector of said input image signal with the superposition of said predetermined image signal started or ended; and
if the command for starting or ending said superposition is accepted, interpolating and outputting said signal between input image signals on the basis of said motion vector regardless of the reliability of said motion vector.

9. An image display apparatus comprising:
detecting means for detecting a motion vector of an input image signal that is an entered time-series image signal;
determining means for determining a level of a reliability of said motion vector;
interpolating means for interpolating and outputting, if the reliability of said motion vector is high, on the basis of said motion vector, a signal between input image signals that is an image signal at a given time between said input image signal and a preceding input image signal that is an input image signal one before the input image signal and, if the reliability of said motion vector is low, outputting said preceding input image signal as said signal between input image signals without change;
accepting means for accepting a command for starting or ending superposition of a predetermined image signal onto said input image signal; and
display means for displaying an image on the basis of said input image signal, said preceding input image signal, or said signal between input image signal,
wherein, if the command for starting or ending said superposition is accepted, said detecting means detects a motion vector of said input image signal with the superposition of said predetermined image signal started or ended and,
if the command for starting or ending said interpolation is accepted, said interpolating means interpolates and outputs said signal between input image signals regardless of the reliability of said motion vector and on the basis of said motion vector.

10. The image display apparatus according to claim 9, further comprising
superposing means for starting or ending, if the command for starting or ending said superposition is accepted, the superposition of said predetermined image signal onto said input image signal.

11. The image display apparatus according to claim 9, wherein said determining means, if a value of said motion vector is smaller than a threshold value, determines that said reliability is high and, if a value of said motion vector is greater than a threshold value, determines that said reliability is low.

12. The image display apparatus according to claim 9, wherein
said determining means determines on the basis of a difference between said input image signal and said preceding input image signal, whether said input image signal is an image signal at a time of scene change, if said input image signal is found to be not an image signal at a time of scene change, determines that said reliability is high and, if said input image signal is found to be an image signal at a time of scene change, determines that said reliability is low.

13. The image display apparatus according to claim 9, wherein
said accepting means and said interpolating means are interconnected via a bus;
said accepting means, upon accepting the command for starting or ending said superposition, transmits a stop signal indicative of stopping of suppression of interpolation by said interpolating means to said interpolating means before said interpolation is started or ended; and
said interpolating means, upon receiving said stop signal transmitted from said accepting means, interpolates and outputs said signal between input image signals on the basis of said motion vector regardless of the reliability of said motion vector.

14. The image display apparatus according to claim 9, wherein
said accepting means, upon accepting the command for starting or ending said superposition, puts a port into a state indicative of stopping suppression of the interpolation by said interpolating means before said superposition is started or ended; and
said interpolating means confirms the state of said port by polling before said superposition is started or ended and, if the state of the port is indicative of stopping of suppression of the interpolation by said interpolating means, interpolates and outputs said signal between input image signals on the basis of said motion vector regardless of the reliability of said motion vector.
